(19) United States
(12) Patent Application Publication
(10) Pub. No.: US 2016/0157479 A1
(43) Pub. Date: Jun. 9, 2016

(54) ANTIFUNGAL COMPOSITION AND METHOD

(71) Applicant: OMEX INTERNATIONAL LIMITED, Hamilton (BM)

(72) Inventors: Ian ELLIOTT, Market Rasen (GB); David BOOTY, Stamford (GB); Bernard H. DAWSON, Fareham (GB); Rachel BRANAGHAN, Fareham (GB)

(21) Appl. No.: 14/908,371

(22) PCT Filed: Aug. 1, 2014
(86) PCT No.: PCT/GB2014/052375

§ 371 Date: Jan. 28, 2016

(30) Foreign Application Priority Data
Aug. 1, 2013 (GB) 1313803.7

(51) Int. Cl. A01N 25/04; A01N 35/04

(52) U.S. Cl. CPC A01N 25/04; A01N 35/04

(57) ABSTRACT

A composition comprising a surfactant, a co-surfactant, and a vanillin or an analogue thereof, that can be used to inhibit the growth of fungus on plants. The composition is diluted with water to form an oil-in-water microemulsion which can be applied to plants to inhibit the growth of fungus on plants.

### FIELD OF THE INVENTION

This invention relates to an antifungal composition and method for agricultural use.

### BACKGROUND TO THE INVENTION

Vanillin (4-Hydroxy-3-methoxybenzaldehyde) is a flavouring agent used extensively in foods, beverages and pharmaceuticals. It is present in natural vanilla extract and is currently synthesised from guaiacol or from lignin. In WO2005/102024A2 its use in the control of certain insects (aphids and heteroptera) on agricultural crops was disclosed. This involved the direct application of an aqueous solution of vanilla to insects on crop leaves.

### SUMMARY OF THE INVENTION

It has now been found that vanillin is effective as an antifungal agent on agricultural crops.

It has also been found that aqueous solutions of vanillin are not effective as inhibitors of fungal growth due to the poor solubility of vanillin in water, chemical instability of the vanillin in the solution and reduced biological activity compared to known fungicides.

Accordingly, the present invention provides a composition comprising a surfactant, a co-surfactant and vanillin or an analogue thereof, that can be used to inhibit the growth of fungus on plants.

According to the present invention the composition is in the form of a microemulsion or is capable of forming a microemulsion on dilution with water.

The invention also provides an oil-in-water microemulsion composition comprising a surfactant, a co-surfactant and vanillin or an analogue thereof, and water, that can be used to inhibit the growth of fungus on plants.

The invention also provides a method of inhibiting the growth of fungus on plants comprising use of a composition comprising a surfactant, a co-surfactant and vanillin or an analogue thereof. Preferably, the composition comprising vanillin is sprayed on to the plants.

The invention also provides a use of a composition comprising a surfactant, a co-surfactant and vanillin or an analogue thereof, in inhibiting the growth of fungus on plants.

### BRIEF DESCRIPTION OF THE FIGURES

FIG. 1 is a graph illustrating rate of decomposition of Vanillin in thin films exposed to the light;

FIG. 2 is a graph illustrating rate of decomposition of Vanillin in thin films in the dark;

FIG. 3 is a graph illustrating rate of decomposition of Vanillin in bulk solution under light;

FIG. 4 is a graph illustrating rate of decomposition of Vanillin in bulk solution in the dark;

FIG. 5 is a bar chart showing percent residual active ingredient after washing;

FIG. 6 is a graph showing the amount of residual active ingredient on the plate after simulated rainfall;

FIGS. 6 to 9 are bar charts showing assessments of efficacy of the control of septoria leaf blotch, respectively 20, 24 and 28 days after inoculation;

FIG. 10 is the scoring key used for disease assessment of Wheat Yellow Rust and Wheat Brown Rust; and

FIGS. 11 to 13 are bar charts showing assessments of efficacy of the control of yellow rust, respectively 14, 18 and 21 days after inoculation.

FIG. 14 is a graph showing the vanillin stability when a photostabiliser is added to the formulation.

FIG. 15 is a bar chart showing the effect of different photostabilisers on the stability of vanillin in the composition.

FIGS. 16 to 18 are bar charts showing assessments of efficacy of the control of brown rust, respectively 7, 10 and 14 days after inoculation.

FIGS. 19 to 21 are bar charts showing assessments of efficacy of the control of powdery mildew, respectively 7, 10 and 14 days after inoculation.

FIG. 22 is a bar chart showing the rain-fastness of vanillin for various compositions.

FIG. 23 is a graph showing the amount of vanillin that penetrates into the leaf for various compositions.

### DETAILED DESCRIPTION OF THE INVENTION

Hereinafter, the present invention will be described in further detail with reference to suitably preferred embodiments. Any combination of the preferred ingredients and amounts herein may be present in the compositions, and the scope of the invention is not limited to the specific combinations and amounts of ingredients disclosed but only by the scope of the accompanying claims.

Unless otherwise specified, all percentages and/or ratios describing the composition refer to the weight/weight fraction of the two components.

In a first aspect, the present invention provides a composition comprising a surfactant, a co-surfactant and vanillin or an analogue thereof. In one embodiment, the composition comprises a surfactant, co-surfactant and vanillin.

Analogues of vanillin include the following compounds: hydroxybenzaldehyde, dihydroxybenzaldehyde, hydroxybenzoic acid, dihydroxybenzoic acid, hydroxybenzyl alcohol and dihydroxybenzyl alcohol, wherein any of the compounds may be optionally substituted with 1 to 3 C₁₋₆ alkyl groups. In one embodiment, the analogues of vanillin include the following compounds: hydroxybenzaldehyde, dihydroxybenzaldehyde, hydroxybenzyl alcohol and dihydroxybenzyl alcohol, wherein any of the compounds may be optionally substituted with 1 to 3 C₁₋₆ alkyl groups.

Analogues of vanillin include, but are not limited to vanillic acid, esters of vanillic acid, vanillyl alcohol, ethyl vanillin, anisaldehyde and salicylaldehyde. In one embodiment, the analogue of vanillin is selected from one or more of vanillic acid, vanillyl alcohol, ethyl vanillin, anisaldehyde and salicylaldehyde. In another embodiment, the analogue of vanillin is selected from one or more of vanillyl alcohol, ethyl vanillin, anisaldehyde and salicylaldehyde. In a further embodiment the analogue of vanillin is salicylaldehyde.

In one embodiment the composition comprises vanillin or an analogue thereof in an amount between about 20% and about 30%. In a further embodiment the composition comprises vanillin or an analogue thereof in an amount between about 23% and about 27%.

The composition of the present invention is a concentrated vanillin formulation that is diluted with water before application to plants. The surfactant and co-surfactant of the composition are selected such that an oil-in-water microemulsion is formed upon dilution with water. In a further embodiment an oil-in-water microemulsion is formed upon dilution of the composition with water to between about 0.01% and about 40%. In another embodiment, an oil-in-water microemulsion is formed upon dilution of the composition with water to between about 0.075% and about 0.8%. In another embodiment, an oil-in-water microemulsion is formed upon dilution of the composition with water to between about 0.1% and about 0.5%. In a further embodiment, an oil-in-water microemulsion is formed upon dilution of the composition with water to between about 0.3% and about 0.5%.

A microemulsion is a system containing an aqueous phase, an organic phase and amphiphiles (surfactants) which is a single optically isotropic and thermodynamically stable composition.

Oil-in-water means that droplets of an organic phase are dispersed in an aqueous phase. Water-in-oil means that droplets of an aqueous phase are dispersed in an organic phase.

In microemulsions, the droplet size of the dispersed phase is typically in the range 5-50 nm, resulting in a transparent or translucent appearance. For emulsions, the droplet size of the dispersed phase is typically 200-1000 nm resulting in an opaque or milky appearance. The dispersed phase is the phase that exists as droplets within the bulk liquid.

Microemulsions are thermodynamically stable and do not phase separate over time. The formation and stability of microemulsions arises from the ultra-low interfacial tension, γ(o/w), between the organic and aqueous phases. In one embodiment, the interfacial tension, γ(o/w), of the microemulsion is about 0.1 mN/m. The ultra-low interfacial tension needed to form microemulsions is provided by a mixed surfactant film at the organic-aqueous interface. The mixed surfactant system may be formed by two surfactants (a surfactant and a co-surfactant) which need to be chemically different so that mixed micellisation does not occur. This means that while the two surfactant molecules need to be adsorbed simultaneously at the interface, they should not interact with each other otherwise their respective activities are reduced and the additive effect needed to produce the ultra-low interfacial tension is not achieved. By convention, the co-surfactant is defined as the surfactant with the lower HLB (hydrophilic-lipophilic balance) value.

In one embodiment, the composition is stable over a temperature range from about −20° C. to about 54° C. In a further embodiment, the composition is stable over a temperature range from about −20° C. to about 20° C.

The HLB value of the surfactant refers to the hydrophilic-lipophilic balance of the surfactant. As would be understood by one skilled in the art, the HLB value of a surfactant is between 0 and 20, where 0 refers to a completely hydrophobic molecule and 20 refers to a completely hydrophilic molecule. The HLB scale is described in J. Soc. Cosm. Chemists, 1, 1949, 311-326; J. Soc. Cosm. Chemists, 5, 1954, 249-256.

In one embodiment the composition comprises between about 5% and about 40% of the surfactant. In another embodiment the composition comprises between about 5% and about 30% of the surfactant. In another embodiment the composition comprises between about 25% and about 30% of the surfactant. In another embodiment, the composition comprises between about 15% and about 20% of the surfactant. In yet another embodiment, the composition comprises between about 10% and about 15% of the surfactant.

In one embodiment the composition comprises the surfactant in a surfactant:vanillin ratio of between about 0.2:1 and about 1.6:1. In another embodiment the composition comprises the surfactant in a surfactant:vanillin ratio of between about 0.2:1 and about 1.2:1. In another embodiment the composition comprises the surfactant in a surfactant:vanillin ratio of between about 0.9:1 and about 1.2:1. In another embodiment, the composition comprises the surfactant in a surfactant:vanillin ratio of between about 0.5:1 and about 0.8:1. In yet another embodiment, the composition comprises the surfactant in a surfactant:vanillin ratio of between about 0.3:1 and about 0.6:1.

In one embodiment the composition comprises between about 5% and about 40% of the co-surfactant. In another embodiment the composition comprises between about 10% and about 30% of the co-surfactant. In another embodiment the composition comprises between about 10% and about 20% of the co-surfactant. In another embodiment, the composition comprises between about 10% and about 15% of the co-surfactant.

In one embodiment the composition comprises the co-surfactant in a co-surfactant:vanillin ratio of between about 0.2:1 and about 1.6:1. In another embodiment the composition comprises the co-surfactant in a co-surfactant:vanillin ratio of between about 0.4:1 and about 1.2:1. In another embodiment, the composition comprises the co-surfactant in a co-surfactant:vanillin ratio of between about 0.4:1 and about 0.8:1. In yet another embodiment, the composition comprises the co-surfactant in a co-surfactant:vanillin ratio of between about 0.4:1 and about 0.6:1.

Herein, the ratios of components relative to vanillin also encompass the ratio of the component to vanillin or an analogue thereof.

The co-surfactant mass ratio is the mass of the co-surfactant divided by the total mass of surfactant (i.e. the mass of the co-surfactant plus the mass of the surfactant). In one embodiment the co-surfactant mass ratio of the composition is between about 0.1 and about 0.9. In another embodiment, the co-surfactant mass ratio is between about 0.25 and about 0.45. In a further embodiment, the co-surfactant mass ratio is about 0.35.

In another embodiment, the co-surfactant mass ratio is between about 0.3 and about 0.6. In a further embodiment, the co-surfactant mass ratio is between about 0.45 and about 0.55. In yet another embodiment, the co-surfactant mass ratio is about 0.5.

The surfactant and/or the co-surfactant may be non-ionic surfactants, ionic surfactants, cationic surfactants, anionic surfactants or zwitterionic surfactants.

In one embodiment, the surfactant and co-surfactant are independently selected from one or more of: nonionic surfactants including ethoxylated alcohols, ethoxylated fatty acid esters, alkoxy block copolymers, poloxamers, polysorbates, alkylpolyglycosides, alkoxylated alkanolamines, amine oxides selected from the group consisting of alkyl di(lower alkyl) amine oxides, alkyl di(hydroxy lower alkyl) amine oxides, alkylamidopropyl di(lower alkyl) amine oxides and alkylmorpholine oxides and other types; or anionic surfactants including alkali metal salts, ammonium salts, amine salts, and amino alcohol salts of (linear and secondary) alcohol sulfates and sulfonates, alcohol phosphates and phosphonates, alkyl sulfates, alkyl ether sulfates, sulfate esters of an alkylphenoxy polyoxyethylene ethanol, alkyl monoglyceride sulfates, alkyl sulfonates, olefin sulfonates, paraffin sulfonates, beta-alkoxy alkane sulfonates, alkylamidoether sulfates, alkylaryl polyether sulfates, monoglyceride sulfates, alkyl ether sulfonates, ethoxylated alkyl sulfonates, alkylaryl sulfonates, alkyl benzene sulfonates, alkyl benzene sulfonic acids, alkylamide sulfonates, alkyl monoglyceride sulfonates, alkyl carboxylates, alkyl sulfoacetates, alkyl ether carboxylates, alkyl alkoxy carboxylates having 1 to 5 moles of ethylene oxide, alkyl sulfosuccinates, alkyl ether sulfosuccinates, alkylamide sulfosuccinates, alkyl sulfosuccinamates, octoxynol or nonoxynol phosphates, alkyl phosphates, alkyl ether phosphates, taurates, N-acyl taurates, fatty taurides, fatty acid amide polyoxyethylene sulfates, isethionates, acyl isethionates, and sarcosinates and acyl sarcosinates preferably, alkyl benzene sulfonates and alkyl benzene sulfonic acids. As used herein, alkyl refers to a C₁₋₂₀ alkyl and lower alkyl refers to C₁₋₈ alkyl.

In one embodiment the surfactant and/or the co-surfactant are non-ionic surfactants. In a further embodiment, the surfactant and co-surfactant are non-ionic surfactants.

In one embodiment the surfactant and co-surfactant are independently selected from one or more of: polysorbates, the polysorbates derived from PEG-ylated sorbitan esterified with fatty acids such as Polysorbate 20 (Polyoxyethylene (20) sorbitan monolaurate), Polysorbate 40 (Polyoxyethylene (20) sorbitan monopalmitate), Polysorbate 60 (Polyoxyethylene (20) sorbitan monostearate), Polysorbate 80 (Polyoxyethylene (20) sorbitan monooleate) (e.g. Tween 80, Tween 40, Tween 20), sodium lauryl sulphate (SLS), poloxamer surfactants i.e. surfactants based on ethylene oxide—propylene oxide block copolymers, ethoxylated alcohols or ethoxylated fatty acid esters.

In one embodiment the surfactant is a polysorbate. In another embodiment the surfactant is selected from one or more of the following: polysorbates derived from PEG-ylated sorbitan esterified with fatty acids such as Polysorbate 20 (Polyoxyethylene (20) sorbitan monolaurate), Polysorbate 40 (Polyoxyethylene (20) sorbitan monopalmitate), Polysorbate 60 (Polyoxyethylene (20) sorbitan monostearate), Polysorbate 80 (Polyoxyethylene (20) sorbitan monooleate) (e.g. Tween 80, Tween 40, Tween 20), sodium lauryl sulphate (SLS). In a further embodiment, the surfactant is Polysorbate 20 (Polyoxyethylene (20) sorbitan monolaurate).

In one embodiment the co-surfactant is selected from one or more of the following: ethoxylated alcohols and ethoxylated fatty acid esters. In another embodiment, the co-surfactant is an ethoxylated alcohol. In a further embodiment, the co-surfactant is castor oil ethoxylate. In particular, castor oil ethoxylate containing 40 moles ethylene oxide per molecule.

In one embodiment the surfactant is selected from one or more of the following: ethoxylated alcohols and ethoxylated fatty acid esters. In another embodiment, the surfactant is an ethoxylated alcohol. In a further embodiment, the surfactant is castor oil ethoxylate. In particular, castor oil ethoxylate containing 40 moles ethylene oxide per molecule.

In one embodiment the co-surfactant is a poloxamer. In a further embodiment, the co-surfactant is poloxamer 331.

In one embodiment the surfactant is a polysorbate and the co-surfactant is an ethoxylated alcohol. In a further embodiment the surfactant is Polysorbate 20 (Polyoxyethylene (20) sorbitan monolaurate) and the co-surfactant is castor oil ethoxylate.

In one embodiment the surfactant is an ethoxylated alcohol and the co-surfactant is a poloxamer. In one embodiment the surfactant is castor oil ethoxylate and the co-surfactant is poloxamer 331.

In one embodiment, the composition also comprises a solvent. In a further embodiment the solvent is capable of dissolving vanillin or an analogue thereof. In another embodiment the solvent is acceptable for use in agriculture. In yet another embodiment, the solvent is a polar solvent. In a further embodiment the solvent is water-miscible. Water-miscible solvents form a homogeneous phase when mixed with water in all proportions.

In yet another embodiment the solvent comprises one or more of: an alcohol, ether, sulfoxide, ketone, lactone, glycol, glycol ether and carboxylic acid. In one embodiment, the solvent is selected from butyl carbitol (diethylene glycol butyl ether) and dimethylsulfoxide. In a further embodiment, the solvent is dimethylsulfoxide. In another embodiment, the solvent is butyl carbitol (diethylene glycol butyl ether).

In one embodiment the solvent is present in an amount between about 10% and about 25%. In a further embodiment the solvent is present in an amount between about 12.5% and about 17.5%. In another embodiment, the composition comprises about 15% of solvent.

In one embodiment the solvent is present in a solvent:vanillin ratio of between about 0.3:1 and about 1:1. In a further embodiment the solvent is present in a solvent:vanillin ratio of between about 0.5:1 and about 0.7:1. In a further embodiment the solvent is present in a solvent:vanillin ratio of about 0.58:1.

In one embodiment, the composition also comprises water. In a further embodiment, the water is present in an amount between 0% and about 40%. In another embodiment, the water is present in an amount between about 2% and about 40%. In another embodiment the water is present in an amount between about 10% and about 20%. In yet another embodiment, the composition comprises between about 10% and about 15% water. In yet another embodiment, the composition comprises between about 13% and about 15% water.

In one embodiment the composition comprises water in a water:vanillin ratio of between 0:1 and about 1.6:1. In another embodiment, the composition comprises water in a water:vanillin ratio of between about 0.05:1 and about 1.6:1. In another embodiment the composition comprises water in a water:vanillin ratio of between about 0.3:1 and about 0.8:1. In yet another embodiment, the composition comprises water in a water:vanillin ratio of between about 0.3:1 and about 0.6:1. In yet another embodiment, the composition comprises water in a water:vanillin ratio of between about 0.5:1 and about 0.6:1.

In one embodiment, the composition is a water-in-oil microemulsion. In a further embodiment, the composition is a water-in-oil microemulsion in its concentrated form and forms an oil-in-water microemulsion when further diluted with water. In yet another embodiment, the composition is a water-in-oil microemulsion in its concentrated form and forms an oil-in-water microemulsion when diluted with water to a concentration of between about 0.01% and about 40%. In a further embodiment, the composition is a water-in-oil microemulsion in its concentrated form and forms an oil-in-water microemulsion when diluted with water to a concentration of between about 0.075% and about 0.8%. In another embodiment, the composition is a water-in-oil microemulsion in its concentrated form and forms an oil-in-water microemulsion when diluted with water to a concentration of between about 0.1% and about 0.5%. In another embodiment, the composition is a water-in-oil microemulsion in its concentrated form and forms an oil-in-water microemulsion when diluted with water to a concentration of between about 0.3% and about 0.5%. The concentration of the microemulsion refers to the amount of the concentrated composition in the microemulsion, for example a concentration of 40% means that 40% of the microemulsion is the undiluted concentrate and 60% of the microemulsion is water.

In one embodiment, the composition comprises an adjuvant. In a further embodiment, the adjuvant is a film-forming agent. A film-forming reagent is any compound that enhances the ability of the composition to form a film on the surface of the plant. The film-forming reagent remains associated with the active ingredient on the surface of the plant and inhibits the removal of the active ingredient by water. The adjuvant forms a vanillin-containing film on the surface of the plant after the volatile components in the composition have evaporated. The film enhances the ability of the vanillin to penetrate into the plant and reduces the amount of vanillin that is washed from the surface of the plant when it rains.

In one embodiment the adjuvant is suitable for use in agriculture. In one embodiment the adjuvant is selected from one or more of: alkyl polyglycosides, polysorbates, polysaccharides, alcohol ethoxylates, block copolymers, ethoxylated tallow amines and alkoxylated fatty alcohols. In another embodiment the adjuvant is selected from one or more of: Agnique PG 8107G, Tween 20, Atplus 2575, Atplus UEP 100, Brij CS 17, Lutensol XL 80, Lutensol TO 8, Lutensol AO 8, Pluronic PE, Tomah E14-2, Tomah E14-5, Plurafac LF 031 and Plurafac LF 431. In a further embodiment, the adjuvant is an alkyl polyglycoside. In a further embodiment, the adjuvant is C8-10 alkyl polyglycoside (Commercially available as Agnique PG 8107G). In one embodiment the composition comprises an adjuvant in an amount between about about 2% and about 15%. In a further embodiment the composition comprises between about 3% and about 6% of adjuvant.

In one embodiment the composition comprises an adjuvant in an adjuvant:vanillin ratio of between about 0.05:1 and about 0.6:1. In a further embodiment the composition comprises an adjuvant in an adjuvant:vanillin ratio of between about 0.1:1 and about 0.25:1.

In one embodiment, the composition comprises a photostabiliser. In a further embodiment, the composition comprises a photostabiliser in an amount between 0% and about 10%. In another embodiment, the composition comprises between about 1% and about 7% of the photostabiliser.

In one embodiment the composition comprises a photostabiliser in a photostabiliser:vanillin ratio of between 0:1 and about 0.4:1. In a further embodiment the composition comprises a photostabiliser in a photostabiliser:vanillin ratio of between about 0.04:1 and about 0.3:1.

The photostabiliser protects other light-sensitive ingredients in the composition from decomposition in the presence of light. The photostabiliser may also act as an antioxidant to further protect the composition from decomposition in the presence of light.

In one embodiment the photostabiliser is suitable for use in agriculture. In a further embodiment the photostabiliser is selected from one or more of Tinoguard TL, Tinoguard TTA, Tinoguard NOA, t-butyl Phenol, t-butylhydroquinone, butylated hydroxyl-anisole, butylated hydroxytoluene, propyl gallate, Hostavin PR-25, Hostavin B-CAP, Hostavin 3362, Nylostab S-EED, Oxynex ST Liquid and ascorbic acid. In another embodiment the photostabiliser comprises diethylhexyl syringyldenemalonate, caprylic/capric triglyceride (commercially available as Oxynex ST). In a further embodiment, the photostabiliser comprises ascorbic acid and diethylhexyl syringyldenemalonate, caprylic/capric triglyceride (Oxynex ST). In yet another embodiment, the photostabiliser comprises ascorbic acid and diethylhexyl syringyldenemalonate, caprylic/capric triglyceride (Oxynex ST) in a ratio of about 0.1:1 to about 5:1, preferably about 0.4:1 to about 2:1, preferably about 0.75:1 to about 1.5:1, preferably about 1:1. In one embodiment, the ascorbic acid is L-ascorbic acid. In yet another embodiment, the photostabiliser comprises L-ascorbic acid and diethylhexyl syringyldenemalonate, caprylic/capric triglyceride (Oxynex ST) in a ratio of about 0.1:1 to about 5:1, preferably about 0.4:1 to about 2:1, preferably about 0.75:1 to about 1.5:1, preferably about 1:1.

It has surprisingly been found that a mixture of ascorbic acid and diethylhexyl syringyldenemalonate, caprylic/capric triglyceride (commercially available as Oxynex ST) is particularly effective as a photostabiliser. Accordingly, the present invention further provides a photostabiliser composition comprising ascorbic acid and diethylhexyl syringyldenemalonate, caprylic/capric triglyceride. In a further aspect there is provided a method of photostabilisation comprising use of such a composition. In one embodiment, the photostabiliser comprises ascorbic acid and diethylhexyl syringyldenemalonate, caprylic/capric triglyceride (Oxynex ST) in a ratio of about 0.1:1 to about 5:1, preferably about 0.4:1 to about 2:1, preferably about 0.75:1 to about 1.5:1, preferably about 1:1. In one embodiment, the ascorbic acid is L-ascorbic acid. In yet another embodiment, the photostabiliser comprises L-ascorbic acid and diethylhexyl syringyldenemalonate, caprylic/capric triglyceride (Oxynex ST) in a ratio of about 0.1:1 to about 5:1, preferably about 0.4:1 to about 2:1, preferably about 0.75:1 to about 1.5:1, preferably about 1:1.

In one embodiment, the composition comprises a leaf-penetrating agent. The leaf-penetrating agent is a surfactant that improves the absorption of vanillin or an analogue thereof, into the leaves of plants. For example, Stock and Holloway (Stock, D. and Holloway, P. J. (1993), Pestic. Sci., 38: 165-177) showed that uptake of lipophilic active ingredients is most enhanced by lipophilic surfactants and the uptake of hydrophilic actives is most enhanced by hydrophilic surfactants.

In one embodiment the leaf-penetrating agent is suitable for use in agriculture. In another embodiment the leaf-penetrating agent is an alkoxylated polyol ester. In a further embodiment the leaf-penetrating agent is alkoxylated polyol ester (commercially available as Atplus UEP 100).

In one embodiment the leaf-penetrating agent is present in an amount between about 5% and about 15%. In a further embodiment the leaf-penetrating agent is present in an amount between about 8% and about 12%.

In one embodiment the leaf-penetrating agent is present in a leaf-penetrating agent:vanillin ratio of between about 0.2:1 and about 0.6:1. In a further embodiment the leaf-penetrating agent is present in a leaf-penetrating agent:vanillin ratio of between about 0.3:1 and about 0.5:1.

In one embodiment, the composition comprises a biocide. The biocide is used to prevent organisms from growing in the composition between manufacture and use.

In one embodiment the biocide is selected from one or more of: benzalkonium chloride, benzisothiazolinone and 2-methyl-isothiazolin-3-one. In another embodiment the biocide is benzalkonium chloride. In a further embodiment the biocide is benzisothiazolinone and 2-methyl-isothiazolin-3-one. In another embodiment the biocide is benzisothiazolinone.

In one embodiment the biocide is present in an amount between 0% and about 5%. In a further embodiment the biocide is present in an amount between about 0.1% and about 1%.

In one embodiment the biocide is present in a biocide:vanillin ratio of between 0:1 and about 0.2:1. In a further embodiment the biocide is present in a biocide:vanillin ratio of between about 0.003:1 and about 0.05:1.

In one embodiment the composition comprises a pH modifying agent. The pH modifier is any compound or composition capable of altering the pH of the composition. The pH modifier adjusts the pH of the formulation such that hydrolysis of the vanillin or analogue thereof is reduced or avoided.

In one embodiment, the pH modifier is an acid. In another embodiment the pH modifier is a buffer. In another embodiment the pH modifier comprises one or more of citric acid, phosphoric acid and a sulfonic acid. In yet another embodiment the pH modifier is a sulfonic acid. In a further embodiment, the pH modifier is dodecylbenzenesulfonic acid. In one embodiment the pH of the composition (in the concentrated form) is less than 7.

In one embodiment the pH modifier is present in an amount between 0% and about 5%. In a further embodiment the pH modifier is present in an amount between about 0.5% and about 2%.

In one embodiment the pH modifier is present in a pH modifier:vanillin ratio of between 0:1 and about 0.2:1. In a further embodiment the pH modifier is present in a pH modifier:vanillin ratio of between about 0.02:1 and about 0.08:1.

In a preferred embodiment of the present invention, the composition comprises vanillin or an analogue thereof, a surfactant, a co-surfactant, a solvent and water. In another preferred embodiment, the composition comprises vanillin, a surfactant, a co-surfactant, a solvent and water. In a further preferred embodiment, the composition comprises vanillin, a surfactant, a co-surfactant, a solvent, water and an adjuvant. In another preferred embodiment, the composition comprises vanillin, a surfactant, a co-surfactant, a solvent, water, an adjuvant and a photostabiliser. In yet another preferred embodiment, the composition comprises vanillin, a surfactant, a co-surfactant, a solvent, water, an adjuvant, a photostabiliser and a leaf-penetrating agent.

In another preferred embodiment of the present invention, the composition comprises vanillin or an analogue thereof in an amount between about 20% and about 30%, a surfactant in a surfactant:vanillin ratio of between about 0.2:1 and about 1.2:1, a co-surfactant in a co-surfactant:vanillin ratio of between about 0.4:1 and about 1.2:1, a solvent in a solvent:vanillin ratio of between about 0.5:1 and about 0.7:1, and water in a water:vanillin ratio of between about 0.3:1 and about 0.8:1.

In another preferred embodiment, the composition comprises vanillin in an amount between about 20% and about 30%, a surfactant in a surfactant:vanillin ratio of between about 0.2:1 and about 1.2:1, a co-surfactant in a co-surfactant:vanillin ratio of between about 0.4:1 and about 1.2:1, a solvent in a solvent:vanillin ratio of between about 0.5:1 and about 0.7:1, and water in a water:vanillin ratio of between about 0.3:1 and about 0.8:1.

In a further preferred embodiment, the composition comprises vanillin in an amount between about 20% and about 30%, a surfactant in a surfactant:vanillin ratio of between about 0.2:1 and about 1.2:1, a co-surfactant in a co-surfactant:vanillin ratio of between about 0.4:1 and about 1.2:1, a solvent in a solvent:vanillin ratio of between about 0.5:1 and about 0.7:1, water in a water:vanillin ratio of between about 0.3:1 and about 0.8:1, and an adjuvant in an adjuvant:vanillin ratio of between about 0.1:1 to about 0.25:1.

In another preferred embodiment, the composition comprises vanillin in an amount between about 20% and about 30%, a surfactant in a surfactant:vanillin ratio of between about 0.2:1 and about 1.2:1, a co-surfactant in a co-surfactant:vanillin ratio of between about 0.4:1 and about 1.2:1, a solvent in a solvent:vanillin ratio of between about 0.5:1 and about 0.7:1, water in a water:vanillin ratio of between about 0.3:1 and about 0.8:1, an adjuvant in an adjuvant:vanillin ratio of between about 0.1:1 to about 0.25:1, and a photostabiliser in a photostabiliser:vanillin ratio of between about 0.04:1 and about 0.3:1.

In yet another preferred embodiment, the composition comprises vanillin in an amount between about 20% and about 30%, a surfactant in a surfactant:vanillin ratio of between about 0.2:1 and about 1.2:1, a co-surfactant in a co-surfactant:vanillin ratio of between about 0.4:1 and about 1.2:1, a solvent in a solvent:vanillin ratio of between about 0.5:1 and about 0.7:1, water in a water:vanillin ratio of between about 0.3:1 and about 0.8:1, an adjuvant in an adjuvant:vanillin ratio of between about 0.1:1 to about 0.25:1, a photostabiliser in a photostabiliser:vanillin ratio of between about 0.04:1 and about 0.3:1, and a leaf-penetrating agent in a leaf-penetrating agent:vanillin ratio of between about 0.3:1 and about 0.5:1.

In a second aspect, the invention provides an oil-in-water microemulsion comprising the composition of the present invention and water. In one embodiment the microemulsion comprises between about 60% and about 99.99% of water. In another embodiment the microemulsion comprises between about 99.2% and about 99.925% of water. In a further embodiment the microemulsion comprises between about 99.5% and about 99.9% of water.

In a further embodiment the oil-in-water microemulsion comprises between about 0.01% and about 40% of the composition in water. In a further embodiment the microemulsion comprises between about 0.075% and about 0.8% of the composition in water. In another embodiment the microemulsion comprises between about 0.1% and about 0.5% of the composition in water. In yet another embodiment the microemulsion comprises between about 0.3% and about 0.5% of the composition in water.

In one embodiment the amount of vanillin in the oil-in-water microemulsion is between about 0.002% and about 10%. In a further embodiment the amount of vanillin in the oil-in-water microemulsion is between about 0.02% and about 0.15%. In another embodiment the amount of vanillin in the oil-in-water microemulsion is between about 0.025% and about 0.1%.

In one embodiment the pH of the composition (in the diluted form) is less than 7. In a further embodiment, the pH of the composition (in the diluted form) is between about 4 and about 5.

In a third aspect, the invention provides a method of inhibiting the growth of fungus on plants using a composition of the present invention. In one embodiment the composition is diluted with water to form a microemulsion before applying said microemulsion to said plants. In a further embodiment the composition is diluted with water to between about 0.01% and about 40% before applying the microemulsion to said plants. In another embodiment the composition is diluted with water to between about 0.075% and about 0.8% before applying the microemulsion to said plants. In yet another embodiment the composition is diluted with water to between about 0.1% and about 0.5% before applying the microemulsion to said plants. In another embodiment the composition is diluted with water to between about 0.3% and about 0.5% before applying the microemulsion to said plants.

In one embodiment the microemulsion may be applied to the plants in need of treatment by spraying, fogging or misting. In a further embodiment the microemulsion may be applied to the plants in need of treatment by spraying.

In a fourth aspect, the present invention provides a use of the composition of the present invention in inhibiting the growth of fungus on plants. In one embodiment the composition is diluted with water to form a microemulsion before applying said microemulsion to said plants. In a further embodiment the composition is diluted with water to between about 0.01% and about 40% before applying the microemulsion to said plants. In another embodiment the composition is diluted with water to between about 0.075% and about 0.8% before applying the microemulsion to said plants. In yet another embodiment the composition is diluted with water to between about 0.1% and about 0.5% before applying the microemulsion to said plants. In yet another embodiment the composition is diluted with water to between about 0.3% and about 0.5% before applying the microemulsion to said plants.

In one embodiment the microemulsion may be applied to the plants in need of treatment by spraying, fogging or misting. In a further embodiment the microemulsion may be applied to the plants in need of treatment by spraying.

The plants that may be treated include agricultural and horticultural crops. In one embodiment the plants that may be treated are annual, biennial or perennial. In another embodiment the plants that may be treated are selected from one or more of the following: soya beans, tomatoes, wheat, vines, grapevines, bananas, strawberries and rice. In a further embodiment the plants that may be treated are selected from one or more of the following: wheat, rice, tomatoes, soyabeans, strawberries, vines and grapevines.

Fungi whose growth may be inhibited by the composition of the present invention include rusts, powdery mildew, rice blast and fungi of the species Septoria, Botrytis, Fusarium and Aspergillus. In one embodiment the fungi whose growth may be inhibited by the composition include: yellow rust, brown rust, soyabean rust, Septoria, Botrytis and Magnaporthe grisea (rice blast). In a further embodiment the fungi whose growth may be inhibited by the composition include: yellow rust on wheat, brown rust on wheat, soyabean rust, Septoria in wheat, Botrytis on grapes, Botrytis on tomatoes, Botrytis on strawberries and Magnaporthe grisea (rice blast) on rice.

Without wanting to be bound by any particular theory, the inhibition of the growth of the fungus of the plants may be caused by the vanillin acting as an antifungal, fungicide, fungistat or elicitor. An elicitor can induce biochemical pathways in a plant that enhance the plant's natural resistance to a pathogen, or that may stimulate the plant's immune system against the pathogen.

The invention will now be described with reference to the following specific formulations.

### Specific Formulations

Formulations containing vanillin have been developed that are water-in-oil microemulsifiable concentrates that could easily be diluted in water to give transparent, thermodynamically stable microemulsions across the temperature range 0-25° C.

### Example 1

### RBEF-06 Microemulsion Formulation

| | | Amount in | |
|---|---|---|---|
| | | composition | Ratio to |
| Component | Trade name | (% w/w) | vanillin |
| Vanillin tech @ 97% | | 25.77 | 1.00 |
| Diethylene glycol | Butyl Carbitol | 15.00 | 0.58 |
| butyl ether | | | |
| Poloxamer 331 | Synperonic PE/L 101 | 17.23 | 0.67 |
| Castor oil ethoxylate | Emulan EL40 | 27.00 | 1.05 |
| Water | | 10.00 | 0.39 |
| Benzalkonium | Surfac BAC 80 | 1.00 | 0.04 |
| chloride (80% | | | |
| solution) | | | |
| C8-10 Alkyl | Agnique PG-8107G | 4.00 | 0.16 |
| polyglycoside | | | |
| TOTAL | TOTAL | 100.00 | |

Physical Properties

Specific Gravity (20° C.)=1.095

pH (asis)=5.8

pH (0.4%)=6.7

Turbidity (asis)=21

Turbidity (0.4%)=1.3

### Example 2

### RBEF-022 Microemulsion Formulation

| | | Amount in | |
|---|---|---|---|
| | | composition | Ratio to |
| Component | Trade name | (% w/w) | vanillin |
| Vanillin tech @ 97% | | 25.77 | 1.00 |
| Dimethylsulfoxide | | 15.00 | 0.58 |
| Polysorbate 20 | Tween 20 | 6.45 | 0.25 |
| Castor oil ethoxylate | Emulan EL40 | 29.78 | 1.16 |
| Water | | 10.00 | 0.39 |
| Benzalkonium chloride | BTC 80E | 1.00 | 0.04 |
| (80% solution) | | | |
| C8-10 Alkyl polyglycoside | Agnique PG-8107G | 5.00 | 0.19 |
| Diethyl hexyl | Oxynex ST liquid | 5.00 | 0.19 |
| syringyldenemalonate, | | | |
| caprylic/capric triglyceride | | | |
| L-Ascorbic acid | | 1.00 | 0.04 |
| Dodecylbenzene sulfonic | Biosoft LA acid | 1.00 | 0.04 |
| acid | | | |
| TOTAL | TOTAL | 100.00 | |

Preparation: The water was added to a vessel and heated to 50° C. The L-ascorbic acid was added and the mixture stirred until fully dissolved. The dimethylsulfoxide and vanillin were added whilst maintaining the temperature at 50° C. until all the crystalline material had dissolved (approximately 10 min). The castor oil ethoxylate, polysorbate 20 and C8-10 alkyl polyglycoside were added sequentially, stirring after each addition. After the final addition, the mixture was stirred until there was complete dissolution and homogeneity. The diethylhexyl syringyldenemalonate, caprylic/capric triglyceride, benzalkonium chloride (80% solution) and dodecylbenzene sulfonic acid were then added sequentially, stirring after each addition.

Physical Properties

Specific Gravity (20° C.)=1.125-1.135 g/mL

pH (0.4%)=3.5-4.5

Turbidity (asis)=<20

Turbidity (0.25%)=<30

### Example 3

### RBEF-024 Microemulsion Formulation

| | | | |
|---|---|---|---|
| | | Amount in | |
| | | composition | Ratio to |
| Component | Trade name | (% w/w) | vanillin |

| | | | |
|---|---|---|---|
| Vanillin tech @ 97% | | 25.77 | 1.00 |
| Dimethylsulfoxide | | 15.00 | 0.58 |
| Polysorbate 20 | Tween 20 | 18.62 | 0.72 |
| Castor oil ethoxylate | Emulan EL40 | 18.61 | 0.72 |
| Water | | 13.90 | 0.54 |
| Benzisothiazolinone | Nipacide BIT20 | 0.10 | 0.004 |
| (20% solution) | | | |
| C8-10 Alkyl | Agnique PG-8107G | 5.00 | 0.19 |
| polyglycoside | | | |
| Diethylhexyl | Oxynex ST liquid | 1.00 | 0.04 |
| syringyldenemalonate, | | | |
| caprylic/capric | | | |
| triglyceride | | | |
| L-Ascorbic acid | | 1.00 | 0.04 |
| Dodecylbenzene | Biosoft LA acid | 1.00 | 0.04 |
| sulfonic acid | | | |
| TOTAL | TOTAL | 100.00 | |

### Example 4

### RBEF-030 Formulation

| | | Amount in | |
|---|---|---|---|
| | | composition | Ratio |
| Component | Trade name | (% w/w) | to vanillin |
| Vanillin tech @ 97% | | 25.77 | 1.00 |
| Dimethylsulfoxide | | 15.00 | 0.58 |
| Polysorbate 20 | Tween 20 | 13.11 | 0.51 |
| Castor oil ethoxylate | Emulan EL40 | 13.12 | 0.51 |
| Water | | 14.90 | 0.58 |
| Benzisothiazolinone/ | Nipacide BSM | 0.10 | 0.004 |
| 2-methyl-isothiazolin-3- | | | |
| one | | | |
| C8-10 Alkyl | Agnique PG-8107G | 5.00 | 0.19 |
| polyglycoside | | | |
| Diethylhexyl | Oxynex ST liquid | 1.00 | 0.04 |
| syringyldenemalonate, | | | |
| caprylic/capric | | | |
| triglyceride | | | |
| L-Ascorbic acid | | 1.00 | 0.04 |
| Dodecylbenzene | Biosoft LA acid | 1.00 | 0.04 |
| sulfonic acid | | | |
| Alkoxylated polyol ester | Atplus UEP 100 | 10.00 | 0.39 |
| TOTAL | TOTAL | 100.00 | |

Physical Properties

Specific Gravity (20° C.)=1.120

pH (asis)=1.84

pH (0.4%)=3.75

Initial Turbidity (0.4%)=1.2 (34.2 ppm water), 0.9 (Cipac D water), 0.6 (Evian mineral water)

The experiments that led to the development of the compositions of the present invention are described below. The effect of the microemulsions obtained from the compositions of the present invention on the growth of fungus on plants is also presented.

### Microemulsion Formulation Development

A number of solvent systems were investigated with the aim of achieving the highest loading possible following low temperature storage. The solvent employed was selected to be non-toxic, applicable under European food laws (amongst others) and able to solvate under conditions acceptable to manufacturing processes. Butyl Carbitol (diethylene glycol butyl ether) is a slow-evaporating, hydrophilic glycol ether with high solvency, surface active and wetting properties. These characteristics allowed stabilisation of high levels of Vanillin in the concentrate at low temperature and also produced the very good dilution characteristics shown later in this report. Once the solvent was chosen, the composition of the surfactant system was examined to impart the best possible dilution characteristics and performance.

It was found that a number of highly ethoxylated linear alcohols caused severe chemical instability of the active ingredient when stored at 54° C. Various storage tests were carried out to establish a chemically inert surfactant system based on a triblock copolymer and an ethoxylated castor oil.

An accelerated storage test on the RBEF-06 composition was carried out to simulate storage of the product for two years at ambient temperature. Samples were stored at 54° C. for 2 weeks, 40° C. for 8 weeks, 4° C. for 8 weeks and 5× freeze-thaw cycles. At the end of each test period the samples were tested for a range of physical properties and the Vanillin content determined analytically by High Performance Liquid Chromatography (HPLC). Results were compared to the data obtained for the initial sample prior to storage.

Vanillin HPLC Method

System: HP1050 Liquid Chromatogram VWD.

Detector: UV/Visible

Column: Spherisorb 5 ODS/2, 5 μm, 250×4.6 mm.

Eluent: 80% Methanol, 20% 0.1 N Acetic Acid

Flow Rate: 2.5 ml/min. (appx 225 Bar)

Wavelength: 223 nm.

Run time: 3.0 minutes (r.t=1.5 mins)

Calibration

A single point calibration, using 97% technical material was carried out at the expected level. Three injections of each standard were performed and the resultant calibration curve plotted.

Sample Analysis

The sample was injected twice and the results expressed as % wt Vanillin (as pure).

TABLE 1
Results

| | | pH (0.4% | |
|---|---|---|---|
| | Vanillin % w/w | solution) | Turbidity asis |
| Initial | 25.01 | 6.84 | 0.9 |
| 2 weeks @ 54° C. | 25.04 (+0.1%) | 6.29 | 1.0 |
| 8 weeks @ 40° C. | 24.91 (−0.4%) | 6.57 | 1.4 |
| 8 weeks @ 4° C. | 25.04 (+0.1%) | 6.77 | 1.1 |

The formulation demonstrates excellent stability at all storage temperatures with losses well within the acceptable level. There are no major fluctuations in alkalinity or turbidity also conferring good stability of the formulation under development.

### Freeze-Thaw Stability

To determine how the microemulsion will react to severe weather conditions a freeze-thaw test was run. Samples were stored at −20° C. for two days before being transferred to a water bath set at 20° C. where the samples were stored for a further two days without agitation. If the samples fully recover to a clear, non-viscous liquid the test is repeated four more times.

After five freeze-thaw cycles the 25% Vanillin microemulsion maintains full stability.

### Dilution Stability

A key feature of this microemulsion formulation is its versatility to be diluted in water of all natures. The microemulsion has been tested in water at 15° C. with standard CIPAC D waters of varying degrees of hardness as a function of calcium carbonate.

TABLE 2
Dilution Stability

| | Turbidity (NTU) | | |
|---|---|---|---|
| Water hardness | 0 hr | 4 hr | 24 hr |
| 1000 ppm | 1.6 | 1.8 | 1.5 |
| 500 ppm | 0.9 | 1.0 | 0.9 |
| 100 ppm | 0.9 | 1.0 | 1.0 |

As noted by the very consistent turbidity measurements the microemulsion maintains good stability throughout the 24 hour test period in waters of varying hardness. The turbidity values indicate a microemulsion of very low particle size which will allow good even coverage and uptake when applied to leaf surfaces.

It was noted by visual assessment that the formulation reduces the contact angle of water considerably and as such a good level of wetting and spreading is expected when applied to leaf surfaces.

### Hydrolytic Stability of Vanillin in Thin Films

This test was designed to follow the stability of Vanillin, diluted to its in-use rate of 0.1% Vanillin, when applied as a thin film to replicate deposits of the spray fluid on leaf surfaces. The test was carried out in conditions of light (laboratory bench) and dark (cupboard) to assess whether photolysis influences the rate of decomposition. Initial active ingredient concentrations were analysed (using the HPLC method above) and left for 5, 12 and 25 days to assess the effect on dry thin films.

Methodology

Van 4 Formulation

| | | Amount in | |
|---|---|---|---|
| | | composition | Ratio to |
| Component | Trade name | (% w/w) | vanillin |
| Vanillin tech @ 97% | | 25.77 | 1.00 |
| Diethylene glycol butyl | Butyl Carbitol | 15.00 | 0.58 |
| ether | | | |
| Poloxamer 331 | Synperonic PE/L 101 | 12.13 | 0.47 |
| Castor oil ethoxylate | Emulan EL40 | 32.00 | 1.24 |
| Water | | 10.00 | 0.39 |
| Dodecylbenzenesulfonic | Nansa SSA | 0.10 | 0.004 |
| acid | | | |
| C8-10 Alkyl | Agnique PG-8107G | 5.00 | 0.19 |
| polyglycoside | | | |
| TOTAL | TOTAL | 100.00 | |

Test formulations: Van 4 (Diluted with water to 0.1% vanillin) and Vanillin solution (0.1%)

Sampling: Complete extraction

Conditions: Light and dark.

Time Periods: 0, 5, 12 and 25 days.

Materials and Method

The two test formulations were run concurrently. Each formulation was diluted to 0.1% Vanillin in CIPAC D standard hard water. 25 ml was transferred by pipette to individual petri dishes and left open in light and dark conditions. After each time interval the dishes were completely extracted with methanol, made up to 25 ml in a volumetric flask and analysed by HPLC. The study was carried out in duplicate.

Results

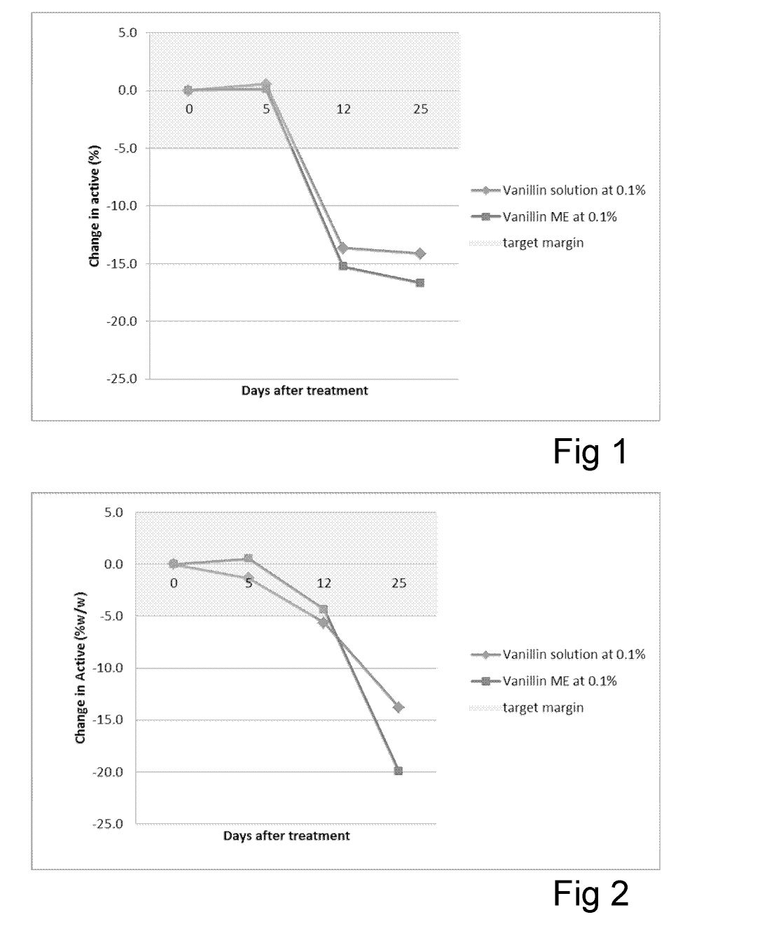

The results are illustrated in FIGS. 1 and 2. As shown by both Figures, the decomposition of Vanillin in both the microemulsion formulation and the solution follow a very similar trend. For the series exposed to daylight we observe no loss of active ingredient in the period 0-5 days, it takes around 7 days to exceed the allowable limit of loss (−5% w/w) after which there is rapid and considerable degradation (−15% w/w Vanillin) until 12 days. At this point the rate of loss is much decreased and the slope of the line decreases. For the series subjected to dark conditions the rate of decomposition appears to be more gradual occurring fairly steadily between 5 and 25 days. At 12 days for both formulations the limit of 5% is breached and as time goes on Vanillin is decomposing rapidly.

In both plots during the initial 5 day period the Vanillin exists in an aqueous environment, there are no losses of Vanillin which therefore implies there is no hydrolytic instability. After 5 days the majority of the moisture has evaporated and it is only at this stage that the active ingredient is exposed to the atmosphere. The water lost by evaporation causes a localised area of high humidity which may explain the degradation as Vanillin is prone to decomposition in moist air. Where the plots level off at 12 days would suggest the point where all the fluid has evaporated and what we are left with is the dry crystalline material. In the case of the series under dark conditions, the humidity would be higher in a closed compartment such as a cupboard and therefore we would expect increased rates of decomposition. As can be seen from FIG. 2, the plots have not begun to level off by 25 days and it can be assumed that a longer time period would be required to reach a maximum.

Practically, this would mean the formulation would be active for the first 5-6 days after initial treatment and subsequently activity would fall off with time. As Vanillin is a systemic antifungal it will need to be absorbed into the leaf structure to exert an effect. The formulation can be modified with the use of humectants or formulated in a controlled release system in order to extend the residuality of the spray fluid deposits if required.

### Hydrolytic Stability of Vanillin in Bulk Liquid.

This test was carried out to examine the stability of Vanillin in bulk solution i.e in a water based concentrate or as a ready-to-use product. The test was also carried out in both light and dark conditions to examine any photolytic effects. Initial active ingredient concentrations were analysed and left for 5, 12 and 25 days to assess the effect in a sealed aqueous environment.

Methodology

Test formulations: Van 4 (Diluted with water to 0.1% vanillin) and Vanillin solution (0.1%)

Sampling: Complete extraction

Conditions: Light and dark.

Time Periods: 0, 5, 12 and 25 days.

Materials and Method

Each formulation was diluted to 0.1% Vanillin in CIPAC D standard hard water. 5 ml was transferred by pipette to a small capped vial and left exposed to sunlight. After each time interval the vials were completely extracted with methanol, made up to 25 ml in a volumetric flask and analysed by HPLC. The study was carried out in duplicate.

Results

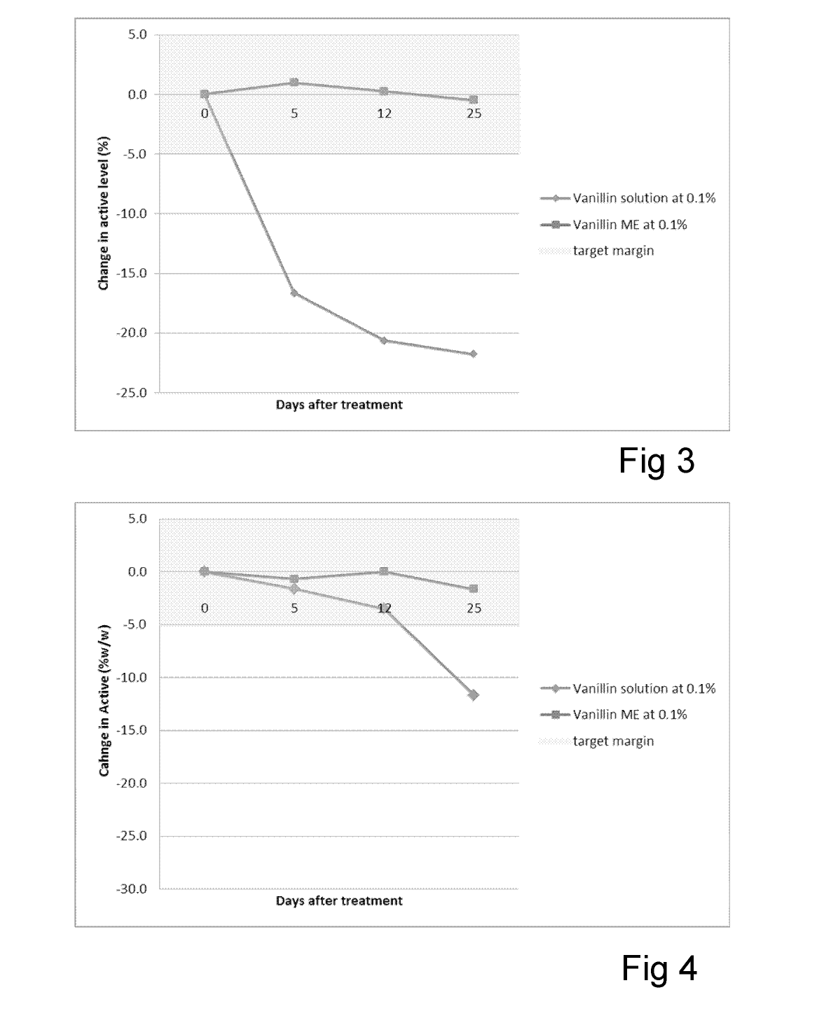

FIGS. 3 and 4 illustrate respectively the rate of decomposition of vanillin in bulk solution in the light and in the dark. In both the light and dark tests the microemulsion remains within the target margin for the duration of the study and is therefore very stable in bulk solution. As indicated in the previous study on thin films, an aqueous environment was stable.

Results for the Vanillin solution do not translate in this way and conversely we see varying rates of decomposition under the differing light conditions. For the series exposed to natural daylight (FIG. 3) the onset of decomposition is immediate and fairly dramatic losing circa 20% of the initial level of Vanillin in 25 days. A similar decline in active concentration in the dark can be seen (FIG. 4) however the rate of loss is much decreased. This can most likely be attributed to bacterial growth in the Vanillin solution resulting in considerable breakdown. This level of degradation is not uncommon for bacterial attack especially as Vanillin acts an excellent food source. In a cool, dark cupboard bacterial growth would be slower consistent with the lower rates of loss in FIG. 4. The microemulsion contains a biocide which would prevent this happening. Clearly with the addition of preservative the dilution is very stable.

### Rainfastness

Preliminary Assessment

Initially, a preliminary study was run in order to screen a number of adjuvants used to enhance the rainfastness of antifungal spray deposits. The adjuvant was incorporated into the concentrated formulation according to the table below and assessed at a dilution rate of 1:200. An aqueous solution of vanillin (VN4—see TABLE 17) was included in the study as the standard control.

TABLE 3
Formulations

| | Van 1 | Van 2 | Van 3 | Van 4 | Van 5 |
|---|---|---|---|---|---|
| Vanillin tech @ | 25.77 | 25.77 | 25.77 | 25.77 | 25.77 |
| 97% | | | | | |
| Butyl Carbitol | 15.00 | 15.00 | 15.00 | 15.00 | 15.00 |
| Synperonic PE/L 101 | 12.13 | 12.13 | 12.13 | 12.13 | 12.13 |
| Emulan EL40 | 32.00 | 32.00 | 32.00 | 32.00 | 32.00 |
| Water | 10.00 | 10.00 | 10.00 | 10.00 | 10.00 |
| Nansa SSA | 0.10 | 0.10 | 0.10 | 0.10 | 0.10 |
| (dodecylbenzenesulfonic | | | | | |
| acid) | | | | | |
| Lutensol XL 80 | 5.00 | — | — | — | — |
| Lutensol TO 8 | | 5.00 | — | — | — |
| Lutensol AO 8 | | | 5.00 | — | — |
| Agnique PG-8107G | | | | 5.00 | — |
| Brij CS 17 | | | | | 5.00 |
| TOTAL | 100.00 | 100.00 | 100.00 | 100.00 | 100.00 |

Method

Each formulation was diluted to 0.375% Vanillin and approximately 1.0 g was applied as a fine mist using a pressurised air spray gun at 2 bar onto a glass petri dish (Ø90 mm) and the weights recorded. The dilution solutions were analysed by HPLC initially in order to calculate the amount of Vanillin applied in mg/l.

The dishes were left to dry for three hours and extracted by washing with 5×1.2 ml of water by micropipette. A rain gauge was used to convert average rainfall into ml/min as follows:

TABLE 4
Rainfall

| Rainfall | mm/hr | ml/hr | ml/min |
|---|---|---|---|
| Light | 2 | 18 | 0.3 |
| Heavy | 8 | 72 | 1.2 |

This volume of water thus equates to 5 minutes of heavy rain and 20 minutes of light rain. The dishes were then extracted with methanol and analysed for residual Vanillin content remaining on the dish after washing.

Results

TABLE 5
Residual active ingredient after wash off

Vanillin (mg/l)

| Formulation | Initial | Washed off | Residual (%) |
|---|---|---|---|
| Van 1 | 390.13 | 218.47 | 44.0 |
| Van 2 | 386.30 | 177.31 | 54.1 |
| Van 3 | 380.64 | 149.59 | 60.7 |
| Van 4 | 376.82 | 97.22 | 74.2 |
| Van 5 | 378.42 | 161.21 | 57.4 |
| VN4 | 394.80 | 365.58 | 7.4 |

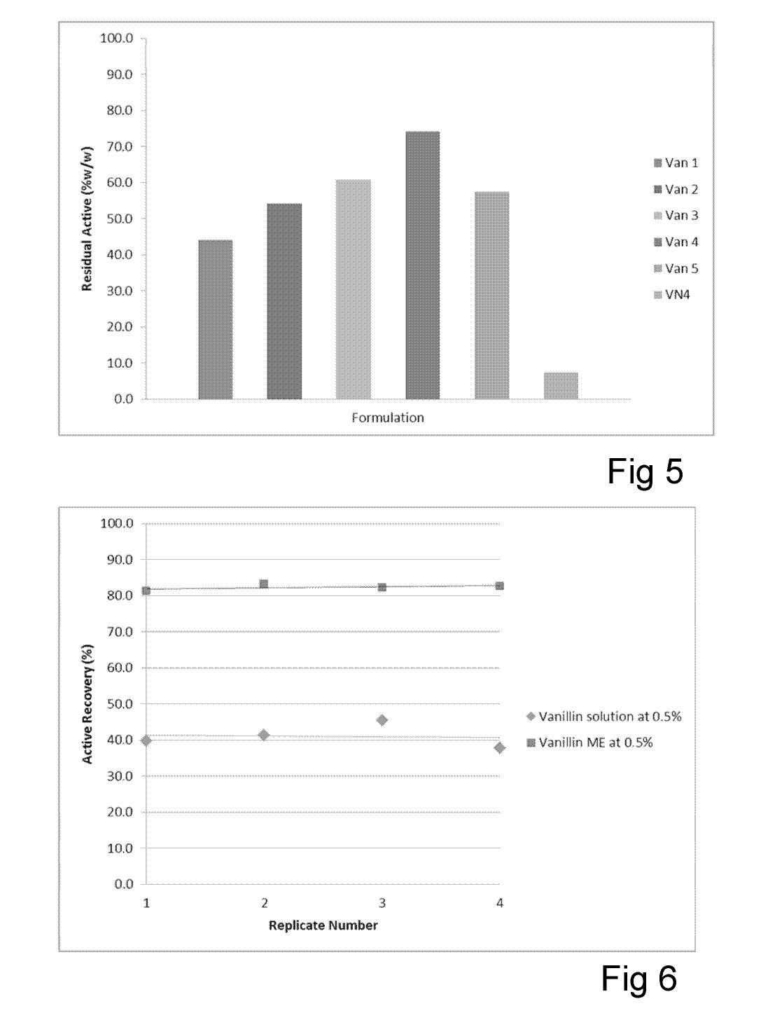

FIG. 5 illustrates graphically the results set out in the Table. These data show a varying ability of the different adjuvants to resist wash-off. Across the series Van 1 to Van 4 the amount of residual active ingredient increases which demonstrates the increasing effectiveness of the various adjuvants. The VN4 formulation (see TABLE 17) demonstrated very poor residuality with approximately 93% of the initial Vanillin deposit being removed by the washings. The other formulations performed better with Agnique PG-8107G in formulation Van 4 giving the greatest residual effect. This adjuvant was studied in more detail in the next extended wash-off test.

### Extended Wash-Off Study

Method

The Van 4 and VN4 compositions (see

TABLE 17 for VN4 composition) were each diluted to 0.5% Vanillin in CIPAC D 342 ppm standard hard water. 5 ml of solution was transferred by pipette to a glass petri dish (90 mm Ø) and left to dry overnight. Once the dishes were dry, 5 ml of CIPAC D water was poured over the surface by pipette and left for 2 minutes. The eluent was collected, made up to 25 ml in a volumetric flask and analysed by HPLC. Each dish was then extracted in methanol for any residual Vanillin and analysed by HPLC. The study was carried out in quadruplicate.

Results

TABLE 6
Extended Wash Off: VN4 Vanillin solution at 0.5% vanillin
Initial 0.5394% 1078.8 mg/l

| | Injection | | | | |
|---|---|---|---|---|---|
| Rep 1 | 1 | 2 | S.D | Average (mg/l) | Average (%) |
| Wash | 627.88 | 627.08 | 0.57 | 627.5 | 58.2 |
| Extraction | 427.7 | 431.24 | 2.50 | 429.5 | 39.8 |
| Recovery | | | | 1057.0 | 98.0 |
| Rep 2 | 1 | 2.00 | S.D | Average (mg/l) | Average (%) |
| Wash | 630.58 | 632.75 | 1.53 | 631.7 | 58.6 |
| Extraction | 443.66 | 446.75 | 2.18 | 445.2 | 41.3 |
| Recovery | | | | 1076.9 | 99.8 |
| Rep 3 | 1 | 2.00 | S.D | Average (mg/l) | Average (%) |
| Wash | 586.41 | 582.80 | 2.55 | 584.6 | 54.2 |
| Extraction | 488.49 | 490.93 | 1.73 | 489.7 | 45.4 |
| Recovery | | | | 1074.3 | 99.6 |
| Rep 4 | 1 | 2.00 | S.D | Average (mg/l) | Average (%) |
| Wash | 648.28 | 648.32 | 0.03 | 648.3 | 60.1 |
| Extraction | 406.87 | 407.06 | 0.13 | 407.0 | 37.7 |
| Recovery | | | | 1055.3 | 97.8 |

TABLE 7
Extended Wash Off: Van 4 Vanillin Microemulsion at 0.5% vanillin -
Initial 0.4863%-984.9 mg/l

| | Injection | | | | |
|---|---|---|---|---|---|
| Rep 1 | 1 | 2 | S.D | Average (mg/l) | Average (%) |
| Wash | 198.17 | 191.93 | 4.41 | 195.1 | 19.8 |
| Extraction | 783.99 | 796.28 | 8.69 | 790.1 | 80.2 |
| Recovery | | | | 985.2 | 100.0 |
| Rep 2 | 1 | 2.00 | S.D | Average (mg/l) | Average (%) |
| Wash | 154.71 | 152.83 | 1.33 | 153.8 | 15.6 |
| Extraction | 800.4 | 817.14 | 11.84 | 808.8 | 82.1 |
| Recovery | | | | 962.5 | 97.7 |
| Rep 3 | 1 | 2.00 | S.D | Average (mg/l) | Average (%) |
| Wash | 163.8 | 164.33 | 0.37 | 164.1 | 16.7 |
| Extraction | 800.67 | 799.90 | 0.54 | 800.3 | 81.3 |
| Recovery | | | | 964.4 | 97.9 |
| Rep 4 | 1 | 2.00 | S.D | Average (mg/l) | Average (%) |
| Wash | 132.08 | 126.25 | 4.12 | 129.2 | 13.1 |
| Extraction | 810.9 | 797.42 | 9.53 | 804.2 | 81.6 |
| Recovery | | | | 933.3 | 94.8 |

FIG. 4 is a plot showing the amount of residual active ingredient on the plate after simulated rainfall. The plot shows the percentage of active ingredient remaining on the plate after the 5 ml wash. In the case of the vanillin solution approximately 40% of active ingredient was retained on the dish vs 80% for the microemulsion. This data shows clearly that the microemulsion system provides a resistance to wash-off by water far superior to that of the Vanillin solution alone. The method has been shown to be very accurate, with recoveries in excess of 95% and very reproducible over four replicates.

Tests were conducted to determine the efficacy of the two formulations RBEF06 and RBEF07 (an aqueous formulation, see TABLE 23) against septoria leaf blotch and yellow rust of wheat.

1. Control of Septoria Leaf Blotch (Mycosphaerella graminicola)

Mycosphaerella graminicola (Septotia tritici) isolate Tibb 2 (triazole R-group 8, cyp 51 amino acid substitutions L50S; S188N; A379G; I381V; N513K) was grown on potato dextrose agar (PDA), amended with penicillin and streptomycin, to eliminate possible bacterial contamination, for 6 d at 200 C. This triazole-insensitive isolate (which is typical of many of today's isolates) was selected to ensure the level of control provided by Opus (epoxiconazole) was representative of common field efficacy, thus enabling valid comparisons with the VNX formulations. Spore suspensions were made by flooding the plates with sterile distilled water and scraping gently. The spore suspensions were adjusted to 106 conidia mL⁻¹, by haemocytometer counts and appropriate dilution, before final re-suspension in potato dextrose broth, amended with 1.5 g L⁻¹ gelatin and 0.5 g L⁻¹ sodium oleate.

Septoria-susceptible winter wheat cv Riband was planted in Levington M3 compost. A total of 12 seeds were planted per 9 cm pot and grown to growth stage 12. Plants were accommodated in a controlled environment room, with a day temperature of 18° C. and a night temperature of 12° C., with 16 h photoperiod, at a photosynthetic photon flux density of approximately 200 μmol m⁻² s⁻¹. Plants were inoculated with M. graminicola by spraying spore suspensions at 106 spores ml⁻¹, to just before run-off. Five replicate pots were used per treatment interaction. The plants were placed in sealed, transparent propagators for 72 h, to maintain high relative humidity. To ensure free water remained on leaves, plants were sprayed with water twice daily during this period. Preventative antifungal applications were made 8 h before inoculation. Treatments were randomised in blocks within the growth room.

All antifungals were applied at the equivalent rate of 200 L water per hectare, using a calibrated pressurised hand-held sprayer. This was achieved by placing plants to be treated in a 1 m² area and applying 20 mL of antifungal sprays. Opus was applied at full rate (1 L ha⁻¹) and at lower rates of 0.5, 0.25 and 0.125 L ha⁻¹. Two VNX formulations were used; RBEF06 and RBEF07. These were applied at 2.4, 1.2, 0.6 and 0.3 L ha⁻¹ for RBEF06 and 4, 2, 1 and 0.5 L ha⁻¹ for RBEF07, thus providing an equivalent dose of VNX for both formulations tested. Control plants were sprayed with sterile distilled water. Disease assessments were made 20, 24 and 28 days by scoring the area of 30 replicate inoculated leaves (leaves 1 and 2) showing Septoria necrosis. Plants were scored in a random sequence using a key which scored leaves as 0, 1, 5, 10, 25, 50, 75 or 100% necrotic.

Results

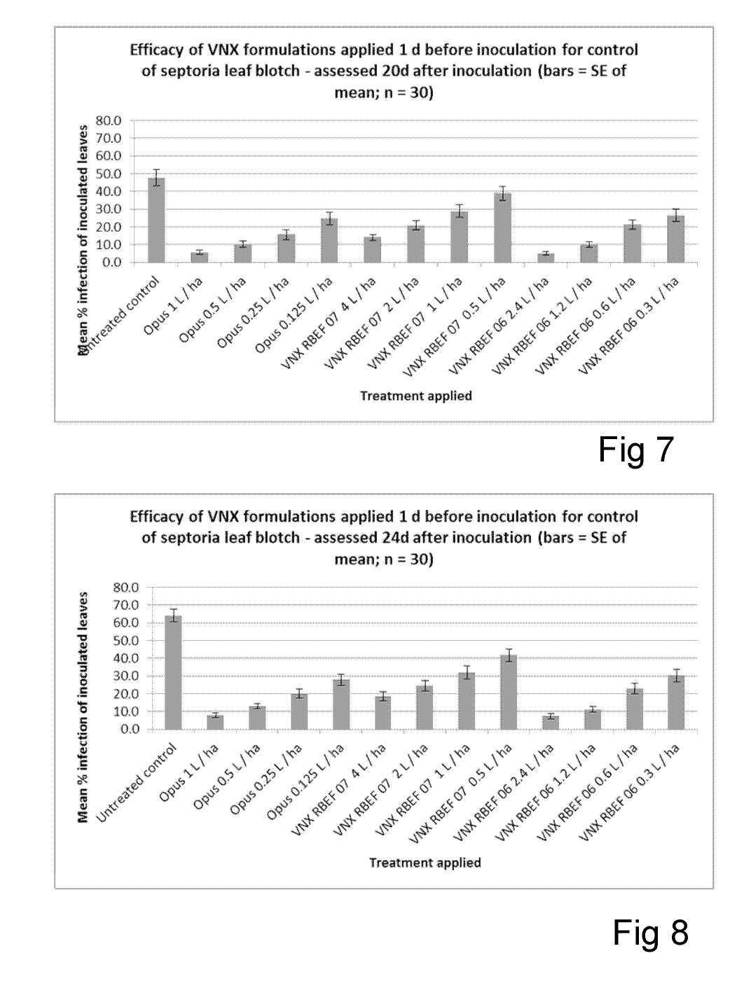

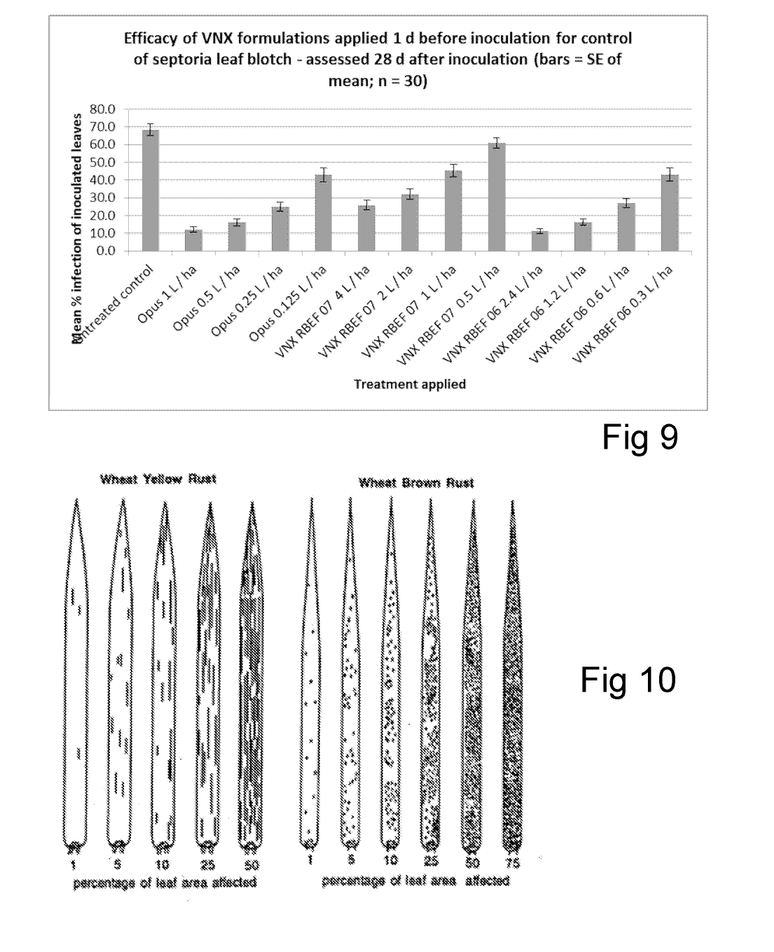

The results obtained are given in a graphical format in FIGS. 7 to 9.

Conclusions
Although epoxiconazole is very widely used, control of the R-8 group isolate of M. graminicola, using Opus™, was incomplete.
Thus a fair comparison with the formulations of the invention was feasible.
Both formulations had activity against septoria leaf blotch of wheat.
The water-based formulation (RBEF07) was less effective than the microemulsion (RBEF06). By the end of the experiment control with 07 was failing.
RBEF06 gives a level of control similar to Opus™ at the range of concentrations tested.
The control provided by the formulations, especially RBEF06, seemed stable with time, and fell-away no faster than that provided by Opus™.
Thus RBEF06 is useful as a preventative treatment for septoria leaf blotch.
   2. Control of Yellow Rust (Puccinia striiformis)

Yellow rust-susceptible winter wheat cv Oakley was planted in Levington M3 compost. A total of 12 seeds were planted per 9 cm pot. Plants were accommodated in a controlled environment room, with a day temperature of 18° C. and a night temperature of 12° C., with 16 h photoperiod, at a photosynthetic photon flux density of approximately 200 μmol m⁻² s⁻¹. Approximately 10 d after sowing, when the first leaf was fully emerged, each pot was irrigated with 10 mL of 0.4% aqueous maleic acid hydrazide. This slows growth and enhances rust development. Twenty pots were set-up and inoculated with spores, recovered from stocks in a −80° C. freezer. Spores were diluted in talc (1:20, v/v) and shaken onto the leaves. Inoculated plants were places in propagators to maintain 100% humidity and incubated in the dark at 10° C. for 12 h. This facilitates spore germination and initial stomatal penetration. The plants were incubated under standard cool glasshouse conditions for 14 d, before fresh spores were harvested by shaking infected leaves over aluminium foil. These spores were used for the experiment proper.

Oakley seeds were then sown and plants grown as described above. Antifungals were applied 1 d prior to inoculation, using the same treatments as those in the septoria leaf blotch control experiment, described above. Five replicate pots were used per treatment interaction. Plants were then inoculated with rust spores in talc and incubated at 10° C. in the dark for 12 h at 100% humidity.

As yellow rust can be a difficult disease to establish, the entire experiment was duplicated. One replicate was maintained in a controlled environment room at a day temperature of 18° C. and a night temperature of 12° C., with 16 h photoperiod; the other replicate was transferred to a glasshouse. Treatments were randomised in blocks.

Disease assessments were made 14, 18 and 21 days after inoculation by scoring the area of 30 replicate inoculated leaves (leaves 1 and 2) showing rust infection. Plants were scored in a random sequence using a key which scored leaves as 0, 1, 5, 10, 25, 50, 75 or 100% infected. The scoring key is illustrated in FIG. 10. As yellow rust does not produce characteristic stripes on seedlings, more a spotting pustule effect, the key for brown rust was more suitable.

When the assessment was started, 14 d after inoculation, the duplicate experiment which gave the higher infection level on untreated control plants was used. This was the glasshouse experiment.

### Results

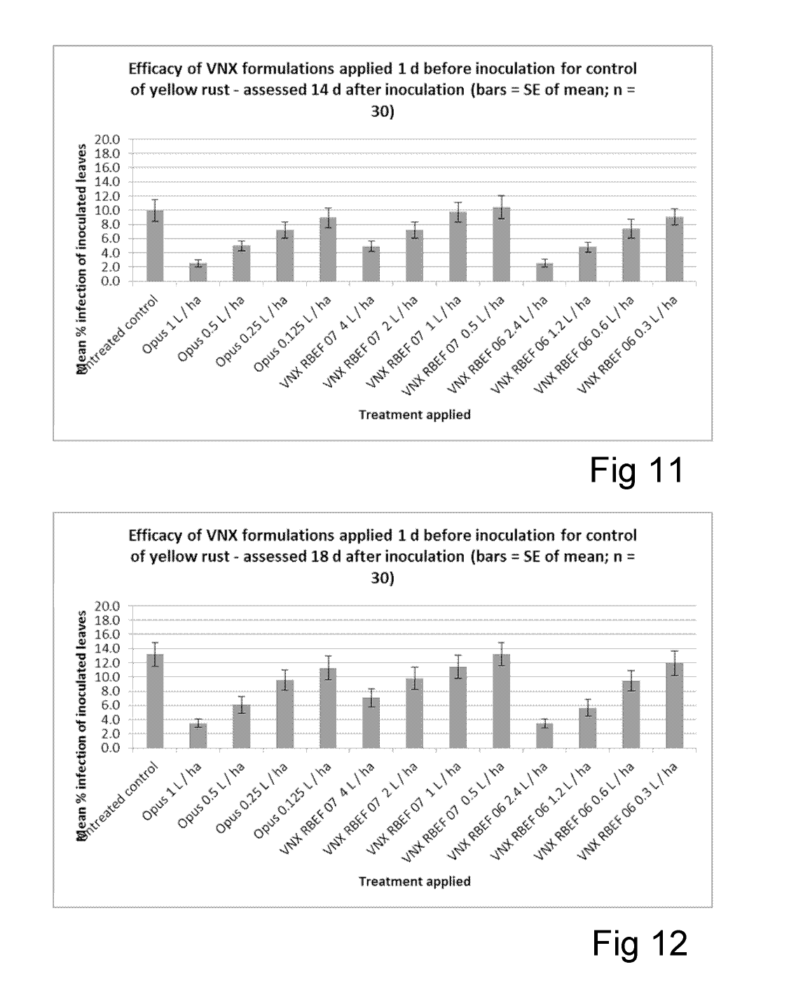

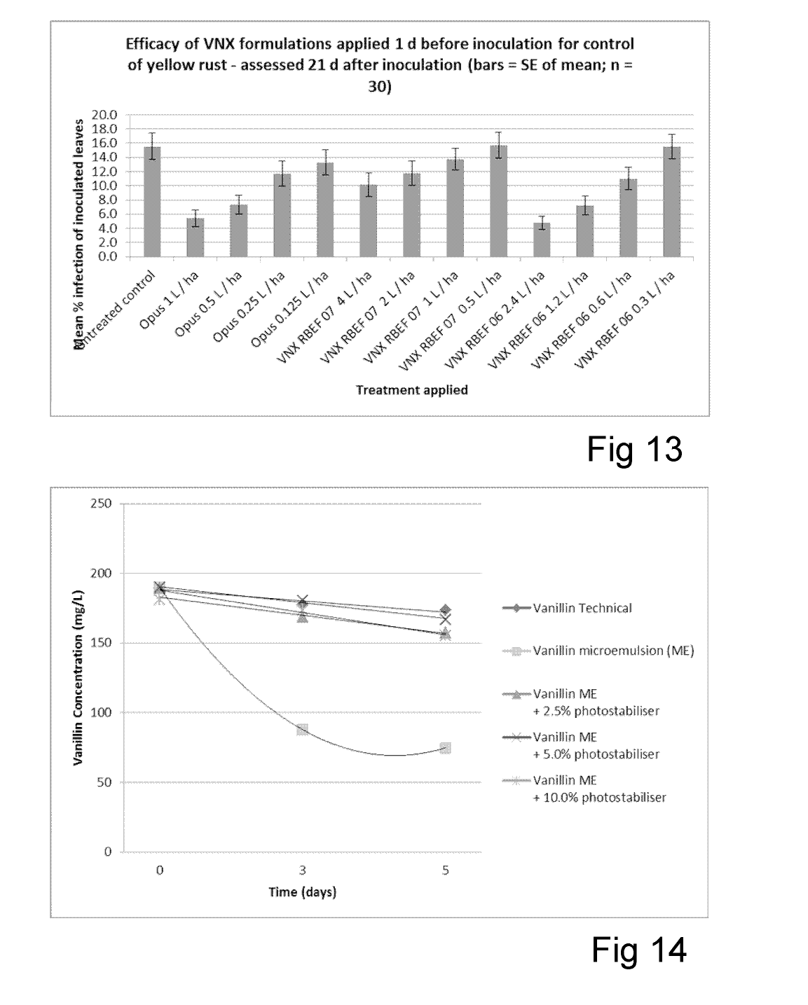

The results obtained are given in a graphical format in FIGS. 11 to 13.

Conclusions
Both formulations had activity against yellow rust of wheat
As with septoria leaf blotch, the water-based formulation (RBEF07) was less effective than the microemulsion (RBEF06).
RBEF06 give a level of control similar to Opus™ at the range of concentrations tested. Note, however, that 1 L ha⁻¹ is equivalent to 125 g active ingredient per hectare and 2.4 L ha⁻¹ RBEF 06 contains 600 g active ingredient, to achieve a similar effect.
Again, the control provided by the formulations, especially RBEF06, was stable over the time-scale of the experiment, and fell-away no faster than that provided by Opus™.

### Light-Fastness Study

A composition without any photostabiliser was used as a base composition (no photostabiliser). Various amounts of Oxynex ST (2.5%, 5% and 10%) were added to the base composition to determine the photostability or light-fastness of vanillin in the microemulsion formulation. The results showed the vanillin in the microemulsion to be unstable in the presence of light. However, this problem could be avoided by the addition of a photostabiliser (Oxynex ST).

TABLE 8
Compositions used in light-fastness study

| | Vanillin ME | ME + 2.5% | ME + 5% | ME + 10% |
|---|---|---|---|---|
| Component | Concentrate | photostabiliser | photostabiliser | photostabiliser |
| Vanillin tech @ 97% | 25.77 | 25.77 | 25.77 | 25.77 |
| Dimethylsulfoxide | 15.00 | 15.00 | 15.00 | 15.00 |
| Tween 20 | 21.12 | 19.87 | 18.62 | 16.12 |
| Emulan EL40 | 21.11 | 19.86 | 18.61 | 16.11 |
| Water | 10.00 | 10.00 | 10.00 | 10.00 |
| BTC 80E | 1.00 | 1.00 | 1.00 | 1.00 |
| Agnique PG 8107G | 5.00 | 5.00 | 5.00 | 5.00 |
| Biosoft LA acid | 1.00 | 1.00 | 1.00 | 1.00 |
| Oxynex ST liquid | — | 2.50 | 5.00 | 10.00 |
| TOTAL | 100.00 | 100.00 | 100.00 | 100.00 |

Method: Each formulation was diluted with water to 0.1% vanillin (as pure) and 5 mL was applied by pipette to a glass petri dish. The dishes were left to stand in a light box fitted with 2×40 W fluorescent daylight bulbs with an illumination intensity of 5000 lux. The dishes were extracted with methanol and made up to 25 mL in a volumetric flask after 3 and 5 days. Samples were then analysed by HPLC.

Calibration: A three point calibration was conducted to span the range 220-20 mg/L. Linearity was achieved with a fit of 99.28%

TABLE 9
Results from light-fastness study

| | Time (days) | | |
|---|---|---|---|
| | 0 | 3 | 5 |
| 0.1% Vanillin Technical in water (mg/L) | 189.36 | 177.65 | 173.29 |
| Loss (%) | ~ | 6.18 | 8.49 |
| Vanillin microemulsion concentrate (ME) | 189.60 | 87.70 | 74.72 |
| (diluted with water to 0.1% vanillin) (mg/L) | | | |
| Loss (%) | ~ | 53.74 | 60.59 |
| Vanillin ME + 2.5% photostabiliser (diluted | 189.37 | 168.43 | 157.51 |
| with water to 0.1% vanillin) (mg/L) | | | |
| Loss (%) | ~ | 11.06 | 16.82 |
| Vanillin ME + 5.0% photostabiliser (diluted | 189.87 | 180.18 | 166.82 |
| with water to 0.1% vanillin) (mg/L) | | | |
| Loss (%) | ~ | 5.10 | 12.14 |
| Vanillin ME + 10.0% photostabiliser (diluted | 180.89 | 173.45 | 155.12 |
| with water to 0.1% vanillin) (mg/L) | | | |
| Loss (%) | ~ | 4.11 | 14.25 |

A graph showing the results of the experiment is shown in FIG. 14.

### Light-Fastness Study—Addition of Ascorbic Acid

The formulations used for these experiments are described in TABLE 10. Oxynex ST (5%) and Oxynex ST (5%) with ascorbic acid (1%) were added to the composition to determine the effect on photostability.

TABLE 10
Compositions used in the study

| | Vanillin ME + 5% | Vanillin ME + 5% Oxynex |
|---|---|---|
| Component | Oxynex ST | ST + 1% ascorbic acid |
| Vanillin tech @ 97% | 25.77 | 25.77 |
| Dimethylsulfoxide | 15.00 | 15.00 |
| Tween 20 | 18.62 | 18.12 |
| Emulan EL40 | 18.61 | 18.11 |
| Water | 10.00 | 10.00 |
| BTC 80E | 1.00 | 1.00 |
| Agnique PG 8107G | 5.00 | 5.00 |
| Biosoft LA acid | 1.00 | 1.00 |
| Oxynex ST liquid | 5.00 | 5.00 |
| Ascorbic acid | — | 1.00 |
| TOTAL | 100.00 | 100.00 |

Method: Formulations were diluted with water to 0.1% vanillin and 5 mL transferred by pipette to a 100 mL crystallising dish. All dishes were placed in a light box containing two 60 cm high efficiency 24 W fluorescent bulbs housed in a canopy to provide bright, full spectrum lighting closely resembling daylight (6400 Kelvin). The dishes were covered with muslin sheets to reduce the intensity of the light to 1500 Lux on a programme of 5 hours per day. At specific time intervals the dishes were extracted and made up to volume with methanol. Samples were analysed by HPLC.

TABLE 11
Results from light-fastness study with ascorbic acid

| | | | | | Vanillin ME + | |
|---|---|---|---|---|---|---|
| | | | Vanillin ME + | | 5% Oxynex ST + | |
| | | | 5% Oxynex ST | | 1% L-ascorbic acid | |
| | 0.1% Vanillin | | (diluted with water | | (diluted with water | |
| | technical in water | | to 0.1% vanillin) | | to 0.1% vanillin) | |
| | Concen- | | Concen- | | Concen- | |
| Time | tration | Loss | tration | Loss | tration | Loss |
| (days) | (mg/dish) | (%) | (mg/dish) | (%) | (mg/dish) | (%) |
| 0 | 5.87 | 0.00 | 5.35 | 0.00 | 5.66 | 0.00 |
| 1 | 5.85 | 0.34 | 5.34 | 0.19 | 5.64 | 0.35 |
| 3 | 5.64 | 3.92 | 5.11 | 4.49 | 5.52 | 2.47 |
| 7 | 5.53 | 5.79 | 4.75 | 11.21 | 5.40 | 4.59 |
| 14 | 5.22 | 11.07 | 3.69 | 31.03 | 4.60 | 18.73 |

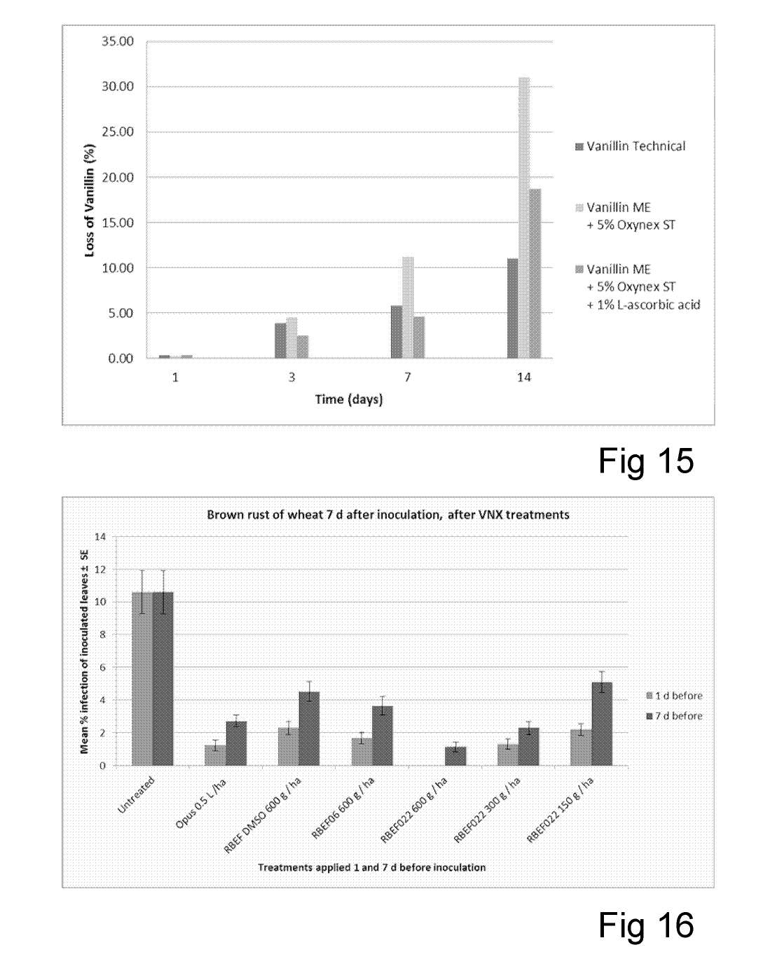

A graph showing the results of the experiment is shown in FIG. 15.

### Light-Fastness Study—Ratio of Ascorbic Acid

The formulations used for these experiments are described in TABLE 12. Various ratios of Oxynex ST and ascorbic acid were used in the composition to determine the effect on photostability.

TABLE 12
Compositions used in the study

| | Oxynex | | |
|---|---|---|---|
| | ST:Ascorbic Acid | | |
| Component | 1:1 | 1:0.5 | 1:0.25 |
| Vanillin tech @ 97% | 25.77 | 25.77 | 25.77 |
| Dimethylsulfoxide | 15.00 | 15.00 | 15.00 |
| Tween 20 | 18.62 | 18.62 | 18.62 |
| Emulan EL40 | 18.61 | 18.61 | 18.61 |
| Water | 13.90 | 13.90 | 13.90 |
| Nipacide BIT 20 | 0.10 | 0.10 | 0.10 |
| Agnique PG 8107G | 5.00 | 5.00 | 5.00 |
| Biosoft LA acid | 1.00 | 1.00 | 1.00 |
| Oxynex ST liquid | 1.00 | 1.33 | 1.60 |
| Ascorbic acid | 1.00 | 0.67 | 0.40 |
| TOTAL | 100.00 | 100.00 | 100.00 |

Method: Formulations were diluted with water to 0.1% vanillin and 5 mL transferred by pipette to a 100 mL crystallising dish. All dishes were placed in a light box containing two 60 cm high efficiency 24 W fluorescent bulbs housed in a canopy to provide bright, full spectrum lighting closely resembling daylight (6400 Kelvin). The dishes were covered with muslin sheets to reduce the intensity of the light to 1500 Lux on a programme of 5 hours per day. At specific time intervals the dishes were extracted and made up to volume with methanol. Samples were analysed by HPLC.

TABLE 13
Light-fastness study showing the effect of the ratio of Oxynex
ST:Ascorbic acid

| | Vanillin (mg/L) | | | Loss | |
|---|---|---|---|---|---|
| Time (days) | 1 | 2 | avg | mg/dish | (%) |
| | 0.1% Vanillin Technical in water | | | | |
| 0 | 201.28 | 200.48 | 200.88 | 5.02 | |
| 1 | 198.02 | 198.95 | 198.49 | 4.96 | −1.19 |
| 2 | 198.76 | 197.78 | 198.27 | 4.96 | −0.11 |
| 3 | 196.44 | 195.47 | 195.96 | 4.90 | −1.17 |
| | Oxynex ST:Ascorbic acid = 1:1 | | | | |
| | (diluted with water to 0.1% vanillin) | | | | |
| 0 | 198.56 | 197.19 | 197.88 | 4.95 | |
| 1 | 199.37 | 198.78 | 199.08 | 4.98 | 0.61 |
| 2 | 200.29 | 199.05 | 199.67 | 4.99 | 0.91 |
| 3 | 192.64 | 191.93 | 192.29 | 4.81 | −2.83 |
| | Oxynex ST:Ascorbic acid = 1:0.5 | | | | |
| | (diluted with water to 0.1% vanillin) | | | | |
| 0 | 206.92 | 206.48 | 206.70 | 5.17 | |
| 1 | 205.01 | 204.62 | 204.82 | 5.12 | −0.91 |
| 2 | 205.95 | 207.44 | 206.70 | 5.17 | 0.00 |
| 3 | 200.15 | 199.70 | 199.93 | 5.00 | −3.28 |
| | Oxynex ST:Ascorbic acid = 1:0.25 | | | | |
| | (diluted with water to 0.1% vanillin) | | | | |
| 0 | 203.80 | 202.11 | 202.96 | 5.07 | |
| 1 | 201.68 | 201.29 | 201.49 | 5.04 | −0.72 |
| 2 | 195.58 | 195.14 | 195.36 | 4.88 | −3.74 |
| 3 | 193.29 | 192.86 | 193.08 | 4.83 | −4.87 |

The data shows that the ratio of Oxynex:Ascorbic acid in the formulation is crucial in reducing the photodecomposition and at an optimum ratio of 1:1, the level of decomposition is reduced in line with that seen with technical vanillin.

### Efficacy of a RBEF-022 and RBEF-06 Formulations Against Powdery Mildew and Brown Rust of Wheat

Inoculum of wheat powdery mildew (Blumeria graminis) was obtained by sowing ten 13 cm pots (20 seeds per pot in Levington M3 potting compost) of the mildew-susceptible wheat variety Claire, and raising them in a glasshouse with a recent history of powdery mildew infection. Two weeks after sowing they were heavily infected, and provided inoculum for the experiment.

A freeze-dried ampoule of brown rust (Puccinia triticina), of a race pathogenic on the commonly-grown variety of winter wheat Solstice, was purchased from NIAB, Cambridge, UK. Solstice seed was planted in Levington M3 compost. A total of 12 seeds were planted per 9 cm pot and grown to growth stage 12. Plants were accommodated in a glasshouse, with venting at 18° C. during the day and night-time heating set to maintain a minimum temperature of 10° C. Initially a population of 20 pots was raised and inoculated, to provide freshly-harvested uredospores for the experiment proper. The freeze-dried spores were diluted with talc (1:20, v:v), placed in a 30 mL universal bottle, which was capped with a single layer of muslin. The spores were then dusted onto the wheat seedlings by shaking the bottle above the target plants. The plants were placed in a propagator to maintain very high relative humidity for 48 h. Uredospores were harvested from 14 d after inoculation and stored in Eppendorf tubes (1.5 mL) and used on the day of harvest to inoculate the experimental plants.

Experimental plants for mildew control, of the variety Claire, were sown in 9 cm pots (12 seeds per pot) and raising the plants in a mildew-free controlled environment room, with a day temperature of 20° C. and a night temperature of 12° C., with 16 h photoperiod, at a photosynthetic photon flux density of approximately 200 μmol m⁻² s⁻¹. For the rust work, clean plants of the variety Solstice were raised under these conditions. When the plants were ready for antifungal application and inoculation, they were transferred to two separate glasshouses (with heating and venting as above), one with a history of mildew and the other mildew-free, the latter being used for the rust work.

Antifungal treatments were applied to three replicate pots, with plants at GS12. All treatments were applied at a volume equivalent to 200 L water per hectare, using a calibrated pressurised hand-held sprayer. This was achieved by placing plants to be treated in a 1 m² area and applying 20 mL of antifungal sprays. The RBEF-006 formulation diluted with water to 0.4% [equivalent to 0.1% vanillin] was applied at a rate equivalent to 600 g of active ingredient (vanillin) per hectare. A simple formulation of 25% technical vanillin in dimethylsulfoxide (RBEF DMSO) diluted with water to 0.4% [equivalent to 0.1% vanillin] was also applied at a similar rate. The diluted RBEF-022 microemulsion formulation was applied at rates equivalent to 600, 300, and 150 g of active ingredient (vanillin) per hectare. As a standard, plants were also treated with Opus (epoxiconazole) at 0.5 L ha⁻¹. Untreated plants acted as a control. Antifungal treatments were applied 1 d and 7 d before inoculation with the pathogens.

Mildew was inoculated by shaking heavily infected source plants over the experimental ones, to deposit a dusting of conidia on the target plants. Rust was inoculated as described above. Disease assessments were carried out at 7, 10 and 14 d after inoculation, by scoring the area of 30 replicate inoculated leaves (leaves 1 and 2). Plants were scored in a random sequence using the keys shown below, which scored leaves as 0, 1, 5, 10, 25, 50, 75 or 100% infected.

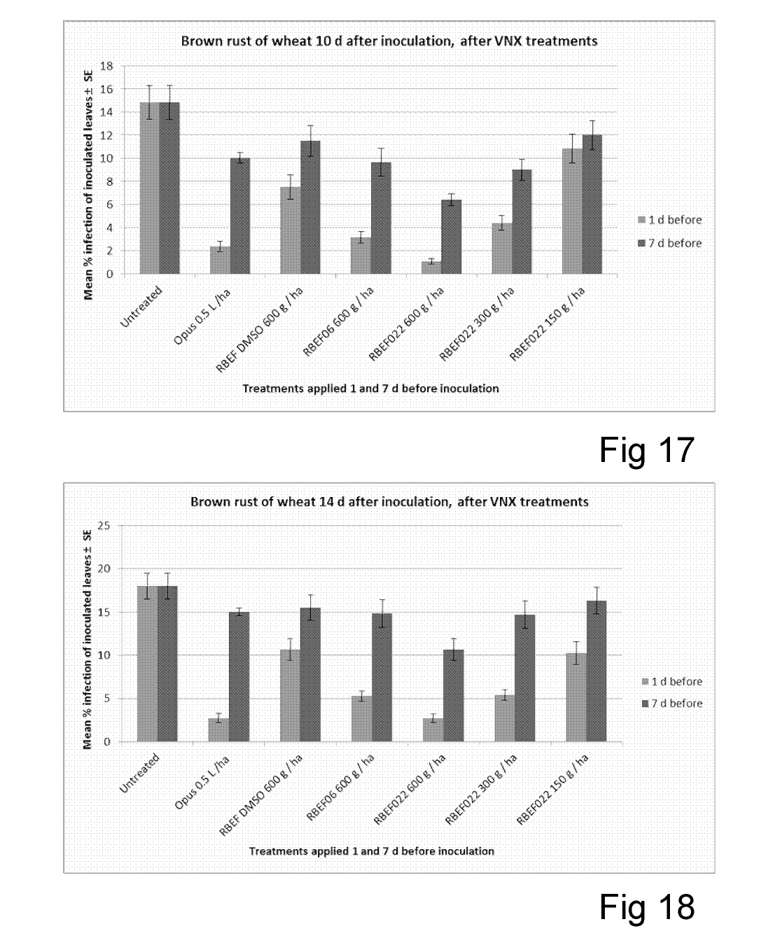

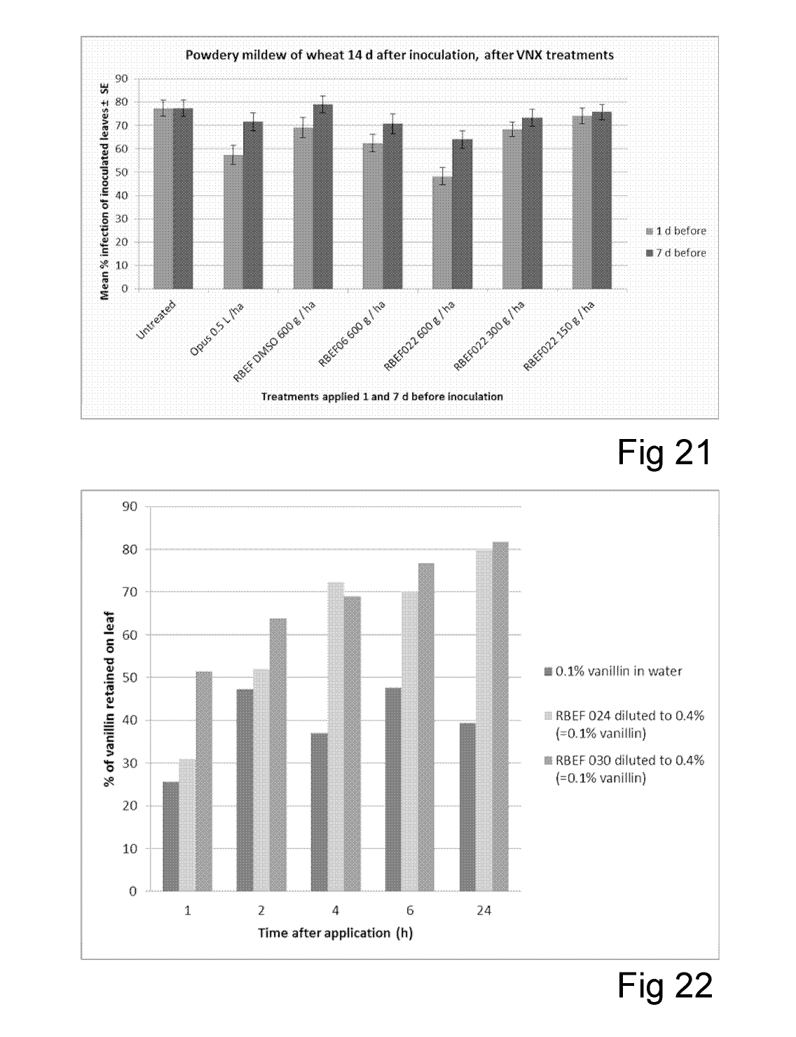

The results of the experiments are shown in FIGS. 16-21. FIGS. 16-18 show the effect of the RBEF-006 and RBEF-022 formulations on brown rust 7, 10 and 14 days after inoculation relative to the untreated control, commercial Opus fungicide and RBEF DMSO formulation. The results show that the formulations are effective at controlling brown rust. Control provided by RBEF 022 was better than RBEF 006 and the DMSO formulation, and for RBEF 022 was as effective as Opus at 0.5 L ha-1, when used as a preventative treatment. Better efficacy was observed when products were applied 1 d before inoculation. However, RBEF 022 provided enhanced persistence, before and after inoculation.

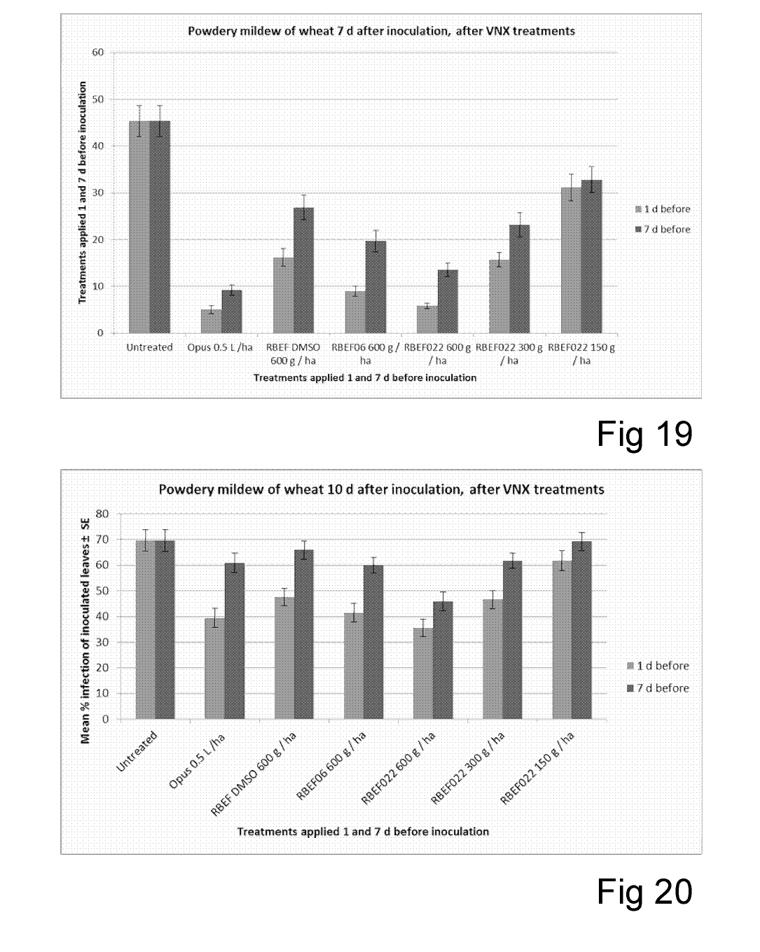

FIGS. 19-21 show the effect of the RBEF-006 and RBEF-022 formulations on brown rust 7, 10 and 14 days after inoculation relative to the untreated control, commercial Opus fungicide and RBEF DMSO formulation. Overall, the disease control of powdery mildew was relatively poor, even when using the commercial Opus (epoxiconazole) standard. This probably reflects the high inoculum pressure, the high susceptibility of the variety used and very conducive conditions. Notwithstanding this, at 600 g of active ingredient (vanillin) per hectare, the RBEF-022 formulation gave a level of control equivalent to Opus at 0.5 L ha⁻¹. Better mildew control was achieved when sprays were made 1 d before inoculation than 7 d before. However, the RBEF-022 formulation gave better persistency, both before and after inoculation.

### Rain-Fastness Study

Method

Cabbage leaf discs (14.5 cm diameter) were cut and placed into 14.5 cm petri dishes. Approximately 1.5-2.0 mL of the diluted concentrate was applied using an artist's spray brush and the weight of deposit measured on a 2 figure balance.

At various time periods (1, 2, 4, 6 and 24 hours) after application the leaf surfaces were washed with 10 mL of water (applied dropwise by pipette) and the washings collected and made up to 25 mL with methanol in a volumetric flask.

The spray dilution was analysed after dilution of 5 mL in 50 mL with methanol as a control.

TABLE 14
Results from rain-fastness study

| | % vanillin retained on leaf after: | | | | |
|---|---|---|---|---|---|
| Formulation | 1 h | 2 h | 4 h | 6 h | 24 h |
| 0.1% vanillin in water | 25.7 | 47.3 | 37.0 | 47.6 | 39.4 |
| RBEF 024 diluted with | 31.0 | 52.0 | 72.3 | 70.1 | 79.7 |
| water to 0.4% | | | | | |
| (=0.1% vanillin) | | | | | |
| RBEF 030 diluted with | 51.4 | 63.8 | 69.0 | 76.8 | 81.8 |
| water to 0.4% | | | | | |
| (=0.1% vanillin) | | | | | |

The results are shown graphically in FIG. 22.

Conclusions

With respect to the solution of vanillin in water, the retention on the leaf surface is not good. Even when the deposit is allowed to dry for 24 hours, approximately 60% of the active ingredient is washed off by simulated rain.

For the two microemulsion formulations (RBEF 024 and 030), the retention is similar (approximately 70-80%) once the deposit is allowed to dry for 4 hours or more.

However, there is an indication with the RBEF 030 formulation that there is some level of rapid penetration in to the leaf sub-surface layers as the amount of retention on the leaf is much higher in the early stages.

### Photodecomposition Study

The following samples were prepared by diluting down the specified composition with water:
VS, vanillin solution in water @ 0.1% vanillin;
0.4% dilution of RBEF-024 (0.1% vanillin); and
0.4% dilution of RBEF-030 (0.1% vanillin).
5 ml of the diluted material was pipetted into 3 pyrex crystallisation dishes; the surface was covered with muslin and the samples placed in a light box for 1, 3 and 5 days respectively with high intensity white light applied for 5 hours out of every 24 hours.

As a control, three equivalent samples were placed in crystallisation dishes which were placed in the dark (inside a cupboard).

At the end of each time period the contents of the crystallisation dishes were washed out with 4×5 mL methanol (magnetic stirrer used at each addition to dissolve any solid vanillin) and the washings transferred to a 25 mL volumetric flask and made up to volume with methanol.

As an initial control (t=0 days), 5 mL of each dilution was pipetted into a 25 mL volumetric flask and made up to volume with methanol.

TABLE 15
Results from photodecomposition study

| | % Vanillin lost by | | | |
|---|---|---|---|---|
| | photo-decomposition | | | |
| Formulation | 0 days | 1 day | 3 day | 5 day |
| Vanillin solution in water @ 0.1% | 0.0 | +0.08 | +1.50 | +2.08 |
| vanillin | | | | |
| 0.4% dilution of RBEF-024 with water | 0.0 | −1.79 | −1.41 | +0.58 |
| (0.1% vanillin) | | | | |
| 0.4% dilution of RBEF-030 with water | 0.0 | +4.12 | −1.58 | +1.39 |
| (0.1% vanillin) | | | | |

Conclusions:

With all systems tested, the amount of vanillin lost due to photo-decomposition is negligible (within experimental error). This clearly demonstrates the effectiveness of the Oxynex ST-Ascorbic Acid system in stabilising the active ingredient.

### Effect of Composition on Leaf-Penetration

14.5 cm cabbage leaf discs were cut and placed in a petri dish and treated with a diluted composition. At the same time a second petri dish (control) was treated with the same diluted composition with no leaf present and stored in the dark for the duration of the test.

Test time periods were 1, 2, 4, 6 & 24 hours after application. The application was performed using an artist's air brush at low pressure to give a deposit of circa 2 g of spray diluted composition.

At the appropriate time period, the leaf disc was washed with methanol and the washings collected and made up to 25 mL with methanol. The appropriate control petri dish was also washed with methanol and the volume made up to 25 mL.

For each treatment a spray control was prepared by diluting 5 mL of spray liquid to 50 mL in a volumetric flask with methanol. The spray control is applied to the leaf and is used to determine the amount of vanillin applied to the leaf surface for each test.

The amount of vanillin washed from the leaf surface was subtracted from the amount washed from the petri dish control to determine how much of the vanillin has moved into the leaf sub-surface layer as a function of the formulation.

TABLE 16
Results from leaf-penetration study

| | % Vanillin penetrating through | | | | |
|---|---|---|---|---|---|
| | leaf cuticle surface | | | | |
| Formulation | 1 hour | 2 hour | 4 hour | 6 hour | 24 hour |
| Vanillin solution in | 0.4 | 2.5 | 1.7 | 5.0 | 8.5 |
| water @ 0.1% vanillin | | | | | |
| 0.4% dilution of | 0.0 | 9.5 | 27.5 | 41.7 | 57.2 |
| RBEF-024 with water | | | | | |
| (0.1% vanillin) | | | | | |
| 0.4% dilution of | 17.0 | 27.3 | 36.3 | 44.3 | 69.7 |
| RBEF-030 with water | | | | | |
| (0.1% vanillin) | | | | | |

Conclusion

The results show that the rate of movement of vanillin across the leaf cuticle surface is minimal with the application of vanillin solution in water, even 24 hours after application.

With respect to the two microemulsion formulations the addition of the Atplus UEP in the RBEF 030 system significantly improves the initial rate of trans-laminar movement in the first 2 hours. The RBEF 024 formulation shows more similar results after 4 hours, although the trans-laminar movement at 24 hours is still higher with the RBEF 030 system.

This data correlates well with the rain fastness studies and suggests that the improved rain fastness in the early period after application of the RBEF 030 system is a consequence of trans-laminar penetration taking the vanillin away from the exposed surface.

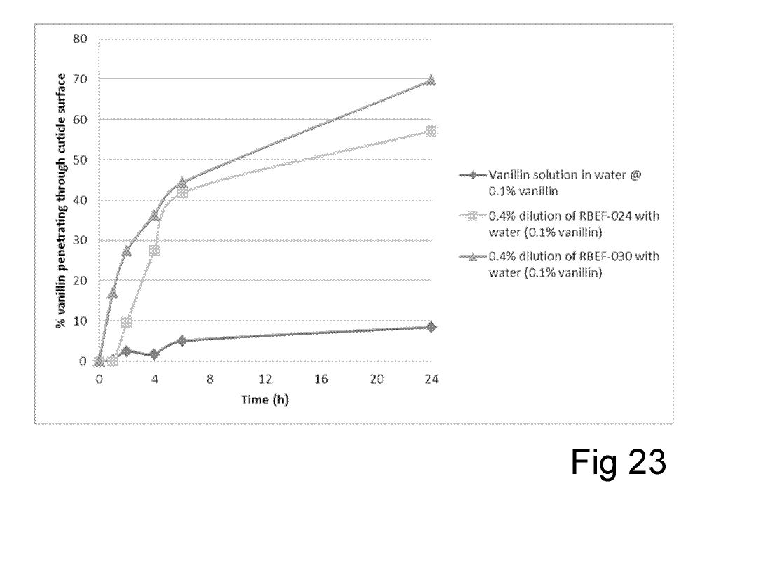

The results are shown graphically in FIG. 23.

### Comparison Example

### Water-Based Formulation Development

An initial water-based system (VN4) was considered, but was found to have some limitations, namely:
Low temperature stability of the concentrate. Severe precipitation occurred after storage at 4° C. for 1-2 weeks.
Poor wetting and spreading characteristics on leaf surfaces.
Poor wash-off performance.

The formulation was as follows:

TABLE 17
VN4 formulation

| Component | VN4 |
|---|---|
| Vanillin | 14.99 |
| Water | 64.47 |
| Sodium bisulphite | 18.74 |
| KOH tech @90% | 1.05 |
| Tergitol 15 S 7 | 0.75 |
| TOTAL | 100.00 |

In this formulation the sodium bisulphite which is a mixture of sodium bisulphite and sodium metabisulphite is used as a preservative to prevent bacterial attack of the active ingredient. The potassium hydroxide increases the solubility of the Vanillin by forming a soluble salt of Vanillin. Tergitol 15 S 7 is a non-ionic alcohol ethoxylate surfactant used to lower the surface tension and improve wetting.

An improved formulation was then sought. A series of derivative formulations was based on the active ingredient: preservative ratio of 1:1.25. Vanillin levels have been adjusted to account for the purity of technical material. Lutensol AO8 was used in this study as the non-ionic surfactant component. Triethanolamine was used to buffer the pH of the system to 7.0-8.0. The concentrates were visually observed after 24 hours at ambient temperatures.

TABLE 18
Formulations and Observations of appearance

| Component | 1 | 2 | 3 | 4 |
|---|---|---|---|---|
| Vanillin tech @ 97% | 15.46 | 15.46 | 15.46 | 15.46 |
| Sodium sulfite | 19.71 | 19.71 | 19.71 | 19.71 |
| KOH (90%) | 1.05 | — | — | — |
| Water | 63.03 | 64.08 | 63.08 | 62.08 |
| Lutensol AO8 | 0.75 | 0.75 | 0.75 | 0.75 |
| Triethanolamine | — | — | 1.00 | 2.00 |
| TOTAL | 100.00 | 100.00 | 100.00 | 100.00 |
| Appearance of concentrate | Turbid, | Clear, | Turbid, | Turbid, crystals |
| | crystals | stable | crystals | |
| pH of concentrate | 6.1 | 4.8 | 7.0 | 8.0 |

As shown in TABLE 18, in formulation 2 the removal of potassium hydroxide appears to increase the stability of the undiluted product. The presence of both potassium hydroxide and triethanolamine seems to have a detrimental effect on the stability. Formulation 2 remained homogeneous and clear but did show slight signs of sedimentation after a number of weeks suggesting the level of preservative is too high.

The role played by the preservative was then examined to try to establish critical levels for the optimisation of stability. The ratio of active:preservative was reduced to 1:1.5 and various combinations of sodium sulphite and sodium benzoate, also commonly used as a preservative, were examined.

TABLE 19

| Component | 5 | 6 | 7 | 8 | 9 |
|---|---|---|---|---|---|
| Vanillin tech @ 97% | 15.46 | 15.46 | 15.46 | 15.46 | 15.46 |
| Sodium sulphite | 17.97 | 13.48 | 8.99 | 4.49 | |
| Sodium benzoate | | 4.49 | 8.98 | 13.48 | 17.97 |
| Water | 65.82 | 65.82 | 65.82 | 65.82 | 65.82 |
| Lutensol AO8 | 0.75 | 0.75 | 0.75 | 0.75 | 0.75 |
| TOTAL | 100.00 | 100.00 | 100.00 | 100.00 | 100.00 |

All formulations were stored at 4° C. and monitored visually for signs of instability. Formulations 5, 6 and 9 all crystallised within 1 week of storage. Formulations 7 and 8 remain clear and stable to the date of reporting (5 weeks).

When submitted to freeze-thaw cycling only formulation 7 passed the five cycles required. The optimum ratio of sodium sulphite:sodium benzoate of 1:1 was then selected (formulation #7 above) and the inclusion of surfactants and adjuvants to improve characteristics such as wetting, stickability and rainfastness considered.

TABLE 20

| Component | #7-1 | #7-2 | #7-3 | #7-4 |
|---|---|---|---|---|
| Vanillin tech @ 97% | 15.46 | 15.46 | 15.46 | 15.46 |
| Sodium sulphite | 8.99 | 8.99 | 8.99 | 8.99 |
| Sodium benzoate | 8.98 | 8.98 | 8.98 | 8.98 |
| Water | 61.57 | 56.57 | 56.57 | 50.82 |
| Emulan EL40 | 3.00 | 2.00 | 3.00 | 0.75 |
| Synperonic PE/L 101 | 2.00 | — | 2.00 | 3.00 |
| Neodol 91-5 | — | 8.00 | — | 2.00 |
| Agnique PG-8107G | — | — | 5.00 | 10.00 |
| TOTAL | 100.00 | 100.00 | 100.00 | 100.00 |

Freeze-Thaw Stability

The four formulations above were put on a freeze-thaw test. After each cycle the sample was left to stand without agitation at 20° C. for two days. If the sample returned to its clear, homogeneous state without being mixed a score of 1 was given. If mixing was required to re-disperse any solid material a score of 2 was awarded. Turbidities were measured after each cycle. The results are shown in TABLE 21.

TABLE 21

| | #7-1 | #7-2 | #7-3 | #7-4 |
|---|---|---|---|---|
| Cycle 1 | 1 | 1 | 1 | 2 |
| Turbidity | 1.5 | 1.0 | 0.8 | 1.4 |
| Cycle 2 | 1 | 1 | 1 | 2 |
| Turbidity | 1.3 | 1.1 | 1.2 | 1.5 |
| Cycle 3 | 1 | 1 | 1 | 2 |
| Turbidity | 1.1 | 1.3 | 1.0 | 1.4 |
| Cycle 4 | 1 | X | 1 | 2 |
| Turbidity | 1.2 | X | 0.9 | 1.6 |
| Cycle 5 | 1 | X | 1 | 2 |
| Turbidity | 0.8 | X | 1.2 | 1.6 |

The results show that the formulations 7-1 and 7-3 recovered very well. Formulation 7-4 required some agitation but recovered within the time frame. Turbidities for these formulations remained consistently low suggesting no breakdown of formulation. Formulation 7-2 did not survive the full five cycles.

Chemical Stability

The formulations below were placed at 54° C. for two weeks. Vanillin content was determined analytically as expressed as % w/w as pure.

TABLE 22
Chemical Stability

| | Active (% w/w pure) | | |
|---|---|---|---|
| Formulation | Initial | 2 wks @ 54° C. | Change |
| Van #7-1 | 14.8 | 14.73 | −0.47 |
| Van #7-2 | 15.2 | 15.17 | −0.20 |
| Van #7-3 | 14.8 | 14.48 | −2.16 |
| Van #7-4 | 14.7 | 12.99 | −11.63 |

The results show that formulations 7-1, 7-2 and 7-3 all demonstrate good chemical stability with loses falling within the +/−5% target margin. Formulation 7-4 loses almost 12% of active ingredient when subjected to 54 C for two weeks and thus is very unstable. It can be inferred that the high level of the adjuvant in this formulation is causing the instability.

From all the data formulation 7-3 was selected as the most promising system. It demonstrates good high temperature chemical stability and very good low temperature physical stability. The formulation contains the same surfactant and adjuvant system as that developed for the microemulsion which was found to perform very well in the tests carried out.

As a result of these tests, a final formulation for the water-based composition was determined, as follows:

TABLE 23
RBEF-07 water-based formulation

| Component | RBEF 07 |
|---|---|
| Vanillin tech @ 97% | 15.46 |
| Sodium sulfite | 8.99 |
| Sodium benzoate | 8.98 |
| Water | 57.57 |
| Emulan EL40 | 3.00 |
| Synperonic PE/L 101 | 2.00 |
| Agnique PG-8107G | 4.00 |
| TOTAL | 100.00 |

Physical Properties:

Specific Gravity (20° C.)=1.178

pH (asis)=5.6

pH (0.4%)=6.8

Turbidity (asis)=0.7

Turbidity (0.4%)=0.8

What is claimed is:

1. A water-in-oil microemulsion composition comprising a surfactant, a co-surfactant, vanillin or an analogue thereof, and water;
wherein the surfactant and the co-surfactant are non-ionic surfactants; and
wherein the vanillin analogue is selected from hydroxybenzaldehyde, dihydroxybenzaldehyde, hydroxybenzoic acid, dihydroxybenzoic acid, hydroxybenzyl alcohol and dihydroxybenzyl alcohol, wherein any of the compounds may be optionally substituted with 1 to 3 C₁₋₆ alkyl groups.

2. The water-in-oil microemulsion composition according to claim 1, further comprising a solvent.

3. The water-in-oil microemulsion composition according to claim 2, wherein the solvent is water-miscible.

4. The water-in-oil microemulsion composition according to claim 2, wherein the solvent comprises one or more of: an alcohol, ether, sulfoxide, ketone, lactone, glycol, glycol ether and carboxylic acid.

5. The water-in-oil microemulsion composition according to claim 2, wherein the solvent is present in a solvent:vanillin ratio of between about 0.3:1 and about 1:1.

6. (canceled)

7. (canceled)

8. The water-in-oil microemulsion composition according to claim 1, wherein the co-surfactant mass ratio is between about 0.1 and about 0.9.

9. The water-in-oil microemulsion composition according to claim 1, wherein the surfactant is present in a surfactant:vanillin ratio of between about 0.2:1 and about 1.6:1; and/or the co-surfactant is present in a co-surfactant:vanillin ratio of between about 0.2:1 and about 1.6:1.

10. The water-in-oil microemulsion composition according to claim 1, wherein the surfactant and co-surfactant are independently selected from one or more of: nonionic surfactants including ethoxylated alcohols, ethoxylated fatty acid esters, alkoxy block copolymers, poloxamers, polysorbates, alkylpolyglycosides, alkoxylated alkanolamines, amine oxides selected from the group consisting of alkyl di(lower alkyl) amine oxides, alkyl di(hydroxy lower alkyl) amine oxides, alkylamidopropyl di(lower alkyl) amine oxides and alkylmorpholine oxides and other types; wherein alkyl refers to a C₁₋₂₀ alkyl and lower alkyl refers to C₁₋₈ alkyl.

11. (canceled)

12. The water-in-oil microemulsion composition according to claim 1, wherein the surfactant is a polysorbate and the co-surfactant is an ethoxylated alcohol.

13. The water-in-oil microemulsion composition according to claim 1, wherein the surfactant is an ethoxylated alcohol and the co-surfactant is a poloxamer.

14. The water-in-oil microemulsion composition according to claim 1, wherein the composition further comprises an adjuvant.

15. The water-in-oil microemulsion composition according to claim 14, wherein the adjuvant is in an adjuvant:vanillin ratio of between about 0.05:1 and about 0.6:1.

16. The water-in-oil microemulsion composition according to claim 14, wherein said adjuvant is a film-forming agent.

17. The water-in-oil microemulsion composition according to claim 16, wherein the film-forming agent is selected from alkyl polyglycosides, polysorbates, polysaccharides, alcohol ethoxylates, block copolymers, ethoxylated tallow amines and alkoxylated fatty alcohols.

18. The water-in-oil microemulsion composition according to claim 1, wherein the composition further comprises a photostabiliser.

19. The water-in-oil microemulsion composition according to claim 18, wherein the photostabiliser is present in a photostabiliser:vanillin ratio of between 0:1 and about 0.4:1.

20. The water-in-oil microemulsion composition according to claim 18, wherein the photostabiliser comprises diethylhexyl syringyldenemalonate, caprylic/capric triglyceride (Oxynex ST).

21. The water-in-oil microemulsion composition according to claim 18, wherein the photostabiliser comprises diethylhexyl syringyldenemalonate, caprylic/capric triglyceride (Oxynex ST) and ascorbic acid.

22. The water-in-oil microemulsion composition according to claim 1, wherein the composition additionally comprises a leaf-penetrating agent.

23. The water-in-oil microemulsion composition according to claim 22, wherein the leaf-penetrating agent comprises an alkoxylated polyol ester.

24. The water-in-oil microemulsion composition according to claim 1, wherein the composition further comprises:
i) a biocide; and/or
ii) a pH modifying agent.

25. (canceled)

26. The water-in-oil microemulsion composition according to claim 1, wherein the composition forms an oil-in-water microemulsion upon dilution with water.

27. The oil-in-water microemulsion comprising the composition of claim 1 and water; wherein the surfactant is present in a surfactant:vanillin ratio of between about 0.2:1 and about 1.6:1; and the co-surfactant is present in a co-surfactant:vanillin ratio of between about 0.2:1 and about 1.6:1.

28. The oil-in-water microemulsion according to claim 27, wherein the water is in an amount between about 60% and about 99.99%.

29. The An oil-in-water microemulsion according to claim 27, wherein the microemulsion comprises between about 0.01% and about 40% of the composition in water.

30. A method of inhibiting the growth of fungus on plants comprising use of a composition according to claim 1.

31. A method of inhibiting the growth of fungus on plants, comprising diluting the composition of claim 1 with water to form a microemulsion and applying said microemulsion to said plants.

32. The method according to claim 30, wherein the composition is diluted with water to between about 0.01% and about 40%.

33. (canceled)

34. (canceled)

35. (canceled)
